(19) United States
(12) Patent Application Publication
(10) Pub. No.: US 2026/0159708 A1
(43) Pub. Date: Jun. 11, 2026

(54) BIO-INK COMPOSITIONS, ENVIRONMENTALLY-SENSITIVE OBJECTS, AND METHODS OF MAKING THE SAME

(71) Applicant: Trustees of Tufts College, Medford, MA (US)

(72) Inventor: Fiorenzo G. Omenetto, Lexington, MA (US)

(21) Appl. No.: 19/380,577

(22) Filed: Nov. 5, 2025

Related U.S. Application Data
(63) Continuation of application No. 17/597,112, now abandoned.
(60) Provisional application No. 62/867,164, filed on Jun. 26, 2019.
(60) Provisional application No. 63/043,019, filed on Jun. 23, 2020.

(51) Int. Cl. C09D 11/04; B41M 5/00; C09D 11/38; D06M 15/15; D06P 1/00; D06P 1/46; D06P 3/04; D06P 5/30

(52) U.S. Cl. CPC C09D 11/04; B41M 5/0047; C09D 11/38; D06M 15/15; D06P 1/004; D06P 1/46; D06P 5/30; D06P 3/04

(57) ABSTRACT

Silkworm silk, has been processed into a variety of new material formats including, hydrogels, ultrathin films, thick films, conformal coatings, 3D porous or solid matrices, fibers and many related material formats. Silk is processed in an all water-based, room temperature, neutral pH environment, is mechanically stable, edible, and biocompatible. Given the favorable material properties, the use of silk-based inks have been used in a variety of controlled chemical and biological material fabrication on the micro- and nano-scale. Tuning of the properties of silk-based inks has led to the utilization of more diverse printing techniques and has expanded the scale and function of the printed substrates.

### CROSS-REFERENCE TO RELATED APPLICATIONS

This application is a continuation of U.S. patent application Ser. No. 17/597,112, filed Dec. 27, 2021, U.S Publication No. 202220267621 (Attorney Docket No. 2095.0458). U.S. patent application Ser. No. 17/597,112 represents the U.S. national stage entry of International Patent Application No. PCT/US2020/039442, filed Jun. 24, 2020, International Pub. No. WO2020264036 (Attorney Docket No. 2095.0457). International Patent Application No. PCT/US2020/039442 claims the benefit of priority to U.S. Provisional Application No. 62/867,164 filed on Jun. 26, 2019 (Attorney Docket No. 2095.0455), and U.S. Provisional Application No. 63/043,019, filed on Jun. 23, 2020 (Attorney Docket No. 2095.0456). The entire contents of each application are incorporated by reference herein.

### BACKGROUND

Screen-printing and inkjet printing are two techniques that are simple, robust, and allow contemporary deposition and patterning of inks onto substrates.

Screen-printing is based on the use of a designed mesh masked with a pattern transferred to the underlying substrate by applying pressure with a squeegee that releases the ink through the designed mesh. It is a robust, fast, and scaled-up process for mass production, however, significant technological gaps are still observable in all production phases, especially in the development and post-processing of the screen-printed materials (e.g., UV curing, temperature annealing in the range of 120-180° C.). Recent research on screen-printing inks has mainly focused on the implementation and improvement of conductive pastes based on fillers, such as silver nanoparticles or carbon-based materials, as part of low-cost solar cells, organic light emitting diodes and wearable electrochemical devices. These inks are mostly based on synthetic polymers and ceramics processed using organic solvents that hamper the addition of active fillers (e.g., chromophores, biological molecules like enzymes and antibodies) to implement sensing devices in a single step that can be pervasively transferred onto multiple surfaces.

Piezoelectric-driven inkjet printing, on the other hand, does not require masking equipment and is generally tailored to achieve smaller resolutions. Specifically, it allows direct transfer of features with sizes in the order of tens of micrometers through drop-by-drop delivery of functionalized inks. Low material consumption, versatility, and compatibility in both ink composition and typology of substrate, enable the mask-less inkjet printing technique to be applied not only within the organic electronics field, but also in the making of biochemical sensors and inducing cell alignment in tissue engineering to manufacture interactive interfaces. In addition, digital manipulation of all inkjet printing process steps enables precise droplet-size deposition and reproducible product performance, rendering inkjet printing as a potential tool for implementing in-situ chemical reactions (i.e., Reactive Inkjet printing (RIJ)) with increased yields, but decreased material consumption for device manufacturing and modification of biomaterials. However, the restricted size (i.e., depending on the nozzle) of the active molecule to be transferred, the limited rheology (i.e., viscosity) of the material to be printed, and the eventual high volatility of the solvents used, are the main drawbacks that hamper a widespread diffusion of this printing technique.

Currently, there remains a need in both analog (screen) and digital (inkjet) printing for the development of a biocompatible, printable, and tunable composition that addresses the aforementioned drawbacks.

### SUMMARY OF THE DISCLOSURE

The present disclosure provides, among other things, biopolymer-based ink compositions for printing applications and the converting inert substrates into interactive and responsive interfaces.

Some embodiments of the present disclosure provide an apparatus comprising an article of manufacture and/or substrate having a surface and an ink composition adhered to at least a portion of the surface. The ink composition comprises silk fibroin, a surfactant, and one or more additive dispersed therein. In some forms, the surfactant is present in the ink composition in an amount sufficient to induce the formation of a silk fibroin matrix that hinders leaching of the one or more additive entrained therein, and induces the silk fibroin matrix to have a random coil secondary structure. In some embodiments, the provided article of manufacture and/or substrate is characterized by its flexibility such that when the article of manufacture and/or substrate contacts an object it substantially conforms to the object's surface.

In some embodiments, the silk fibroin matrix is a hydrogel.

In some embodiments, the surfactant comprises a cationic surfactant. The cationic surfactant may comprise an alkyl-amino moiety. For example, in some embodiments, the cationic surfactant is selected from decyl trimethyl ammonium bromide, dodecyl trimethyl ammonium bromide, cetyl trimethyl ammonium bromide, and stearyl trimethyl ammonium bromide. The surfactant may be present in the ink composition in an amount between 0.01 to 10% (w/w).

In some embodiments, the provided ink composition is characterized as having a viscosity that ranges between 1 cP and 10 cP, or between 1 cP and 5 cP.

In some embodiments, the provided ink composition is characterized having silk fibroin present in an amount between 1 to 10% (w/w).

In some embodiments, the additive in the ink composition is selected from a dye, a pigment, a conductive ink, and an active biomolecule. In some embodiments, the one or more additive comprises an environmental responsive dye.

In some embodiments, the ink composition forms a pattern on the surface of the article of manufacture and/or substrate. For example, the pattern may form a sensor. In some embodiments, the article of manufacture and/or substrate is a textile or fabric, such as silk.

In some embodiments, the silk fibroin matrix retains at least 20% (w/w) of the one or more additive upon submerging the article of manufacture and/or substrate in an acidic solution or basic solution. For example, the silk fibroin matrix may retain at least 20% (w/w) of the one or more additive upon submerging the article of manufacture and/or substrate in an acidic solution or basic solution for at least 2 wash cycles, or at least 3 wash cycles, or at least 4 wash cycles or at least 5 wash cycles in an acidic solution or basic solution.

Some embodiments of the present disclosure provide an apparatus comprising an article of manufacture and/or substrate having an exterior surface and pores, wherein the article of manufacture and/or substrate is characterized by its flexibility such that when the article of manufacture and/or substrate contacts an object it substantially conforms to the object's surface. The article of manufacture and/or substrate may include an ink composition extending at least partially into the pores and adhered to at least a portion of the exterior surface, where the ink composition comprises a silk fibroin matrix and one or more additive dispersed therein. The silk fibroin matrix may retain at least 20% (w/w) of the one or more additive upon submerging the article of manufacture and/or substrate in an acidic solution or basic solution.

Some embodiments of the present disclosure provide a method of making an article of manufacture and/or substrate. The method includes (a) depositing a layer of a silk fibroin solution on a surface of an article of manufacture and/or substrate, and (b) depositing a surfactant onto the layer of the silk fibroin solution in an amount sufficient to induce the silk fibroin solution to transform into a silk fibroin matrix having one or more additive entrained therein. In some embodiments, the one or more additive is deposited on the article of manufacture and/or substrate in either step (a) or (b). In some embodiments, when the silk fibroin matrix cures it is adhered to the article of manufacture and/or substrate. In some embodiments, the article of manufacture and/or substrate is characterized by its flexibility such that when the article of manufacture and/or substrate contacts an object it substantially conforms to the object's surface.

In some embodiments, step (a) includes printing the silk fibroin solution onto the surface of the article of manufacture and/or substrate.

In some embodiments, step (a) includes inkjet printing the silk fibroin solution thorough a nozzle of an inkjet printer onto the surface of the article of manufacture and/or substrate.

In some embodiments, the present disclosure provides a coated article. The coated article includes a substrate forming a three-dimensional hierarchical body. The body has opposing ends on respective opposing surfaces of the body defining a first surface and a second surface. The coated article includes an array of sensing elements in contact with the first surface of the substrate forming a pattern across the first surface, the sensing elements being transformable from a first chemical-physical state to a second chemical-physical state in response to a change in one or more environmental parameter. In some embodiments, the array of sensing elements are composed of (i) silk fibroin and (ii) a sensing additive.

In some embodiments, the present disclosure provides a coated article. The coated article includes a substrate forming a three-dimensional hierarchical body. The body has opposing ends on respective opposing surfaces of the body defining a first surface and a second surface. The coated article includes a first sensing element in contact with the first surface of the substrate forming a pattern across the first surface, and a second sensing element in contact with the second surface of the substrate forming a second pattern across the second surface. Each of the sensing elements are transformable from a first chemical-physical state to a second chemical-physical state in response to a change in one or more environmental parameter. In some embodiments, the sensing elements are composed of (i) silk fibroin, and (ii) a sensing additive.

These and other advantages and features of the present invention will become more apparent from the following detailed description of the preferred embodiments of the present invention when viewed in conjunction with the accompanying drawings.

### DESCRIPTION OF THE DRAWINGS

FIG. 1(A-B) are a schematic illustrations of a coated article having an array of sensing elements in accordance with some embodiments of the present disclosure.

FIG. 2(A-D) are exemplary graphs characterizing the biomaterial-based inks screen-printed on conformal interfaces (e.g., crepe de chine) to colorimetrically detect pH variations. FIG. 2A is a calibration of colorimetric sensors: the pictures show the color changes of each indicator (i.e., from top to bottom BG, NY, and PR) at pH values ranging between 3-10, at steps of 0.5. The curves allow quantifying the signal as variations in either Red (i.e., BG and NY) or Green (i.e., PR) channel intensity vs pH. Experimental data are fitted with regression analysis resulting in a calibration model for the best-fit sigmoid curve. FIG. 2B is a graph illustrating reversible behavior of colorimetric sensors: the pictures show color changes of each indicator when pH shifts from a basic to an acidic environment (i.e., BG and NY) and vice versa (i.e., PR) for 9 times. The curves allow quantifying the signal as variations in the Red (R) (i.e., BG and NY) or Green (G) (i.e., PR) channel intensity vs pH, over time. FIG. 2C is a photo that shows biomaterial-based inks embedding a pH indicator before screen-printing. Ink viscosity profiles (i.e., Viscosity, n, vs shear rate, s⁻¹), during Steady Rate Sweep tests. FIG. 2D is a graph illustrating tensile strength of screen-printed crepe de chine. Stress-stretch curves are recorded at a speed of 5 mm/min. The inset shows stress variations at low stretch ranges (λ 1-1.04).

FIG. 3 illustrates SEM Images (left) and pictures (right) of screen-printed substrates before (i.e., time 0) and after scratch test (i.e, after 10 and 15 cycles of abrasion).

FIG. 4(A-B) are pH graphs (FIG. 4A) and a table (FIG. 4B) illustrating pH data acquired using a coated article attached to a subject's arm and neck over time.

FIG. 5 is a calibration graph of screen-printed biomaterial-based inks on crepe de chine after scratch test (i.e., after 15 cycles of abrasion) with color changes quantified as variations in the Red (i.e., BG and NY) or Green (i.e., PR) channel intensity vs pH in the range 3-9.

FIG. 6 are graphs illustrating absorbance spectra of an article of manufacture and/or substrate comprising the ink compositions according to some embodiments of the present disclosure. FIG. 6 (left) shows the variation in the absorbance spectra of the deionized water based washing solution sampled after 5, 10, 30, and 60 minutes of vigorous vortexing. FIG. 6 (middle) shows that absorbance is stable overtime within the range 400-450 μm (i.e., accounting for MR leaching after 60 minutes of vigorous vortexing), suggesting enhanced MR entrapment through RIJ. The silk/CTAB hydrogel can act as a cage that physically traps MR, hampering its leaching through charge effects. FIG. 6 (right) shows the variations on the Green channel depending on pH changes during repetitive washing cycles of photo paper withholding a layer of “silk/CTAB/dye.”

FIG. 7(A-B) are graphs illustrating the variations on the blue and green light intensity channel depending on pH a silk/CTAB/PR photopaper and a silk/CTAB/MR silk fabric according to some embodiments of the present disclosure.

FIG. 8(A-C) are exemplary graphs and charts of data acquired with a coated article and a pH sensor in accordance with embodiments of the present disclosure.

FIG. 9 is a calibration graph of screen-printed water-based enzymatic inks on cotton to detect lactate variations in the concentration range 1-50 mM. The color change is quantified as the Euclidean Distance in the RGB color space and compared to lactate concentrations. The inset highlights intensities variations vs lactate concentrations on the logarithmic scale. Images of screen-printed colorimetric water-based enzymatic inks that detect lactate variations at 1, 5, 10, 25 and 50 mM.

FIG. 10 is a calibration graph of screen-printed silk-based enzymatic inks on cotton to detect lactate variations in the concentration range 1-50 mM. The color change is quantified as the Euclidean Distance in the RGB color space and compared to lactate concentrations. The inset highlights intensities variations vs lactate concentrations on the logarithmic scale. Images of screen-printed colorimetric silk-based enzymatic inks that detect lactate variations at 1, 5, 10, 25 and 50 mM.

FIG. 11(A-B) illustrate a table of variations in sensitive active areas (AA), and a graph illustrating % ED vs. time. FIG. 11A illustrates variations of sensitive active areas (AA) when water and silk-based inks screen-printed on cotton are interacting with 50 mM lactate and they are kept at 75° C. for 2, 9, 31, and 114 hours. 100% indicates that the sensing pattern works entirely (i.e., dark magenta). Degradation of enzymatic activity is indicated by the presence of yellow sections that reduce the size of the dark magenta area. FIG. 11B is a graph illustrating % ED vs time for a silk-based lactate sensing pattern on cotton interacting with 50 mM lactate from 0 hours to 114 hours. Inactive areas appeared as yellow spots and active areas appeared as dark magenta areas within the same letter and estimating variations of overall (i.e.: red fill, silk; blue fill, water) and localized (i.e.: red line, silk; blue line, water) activities during accelerated aging tests. The activity is first monitored at room temperature. The substrates are then kept at 75° C. for 114 hours and both overall and localized activities are monitored after 2, 9, 31 and 114 hours showing the ability of silk-based inks to preserve better localized enzyme activities after 114 hours (i.e. % ED vs time).

FIG. 12 is a perspective view of a coated article comprising a substrate having opposing ends on respective opposing surfaces of the body in accordance with some embodiments of the present disclosure.

FIG. 13 is a cross-sectional view of the coated article of FIG. 1 in accordance with some embodiments of the present disclosure.

FIG. 14 is a schematic illustration of entangled fibers forming woven, knitted, non-woven, nets, braided, and tufted arrangements.

FIG. 15 is a perspective view of a coated article comprising a substrate that forms a three-dimensional hierarchical body having opposing ends on respective opposing surfaces of the body in accordance with some embodiments of the present disclosure.

### DETAILED DESCRIPTION

In some embodiments, the present disclosure provides biologically-based ink compositions, methods of making the biologically-based ink compositions, as well as articles, objects, devices and/or apparatuses fabricated from or that comprise the biologically-based ink compositions. In some embodiments, the biologically-based ink compositions are suitable for printing, applying, coating, extending, and/or extruding on a substrate. Suitable substrates include, but are not limited to, soft and conformal substrates (e.g., paper, textiles), as well as hard substrates (e.g., plastic, ceramic, metal). Various embodiments according to the present disclosure are described in detail herein.

In some embodiments, the biologically-based ink compositions of the present disclosure have improved stability and durability over conventional bio-ink compositions. For example, various embodiments of the present disclosure provide biologically-based ink compositions that exhibit reduced leaching of additives, improved colorfastness, improved abrasion resistance, and/or preserve the flexibility and comfort of the substrate (i.e. soft, conformal, and wearable substrates such as cotton, paper, or crepe de chine silk fabric).

The biologically-based ink compositions may be used in a wide range of applications including, but not limited to, biomedical and tissue engineering, consumer products, drug delivery, imaging, medical/surgical devices, optoelectronics, photonics, sensors, synthetic biology, and/or therapeutics. Substrates or objects may be functionalized and/or patterned with the ink composition to crease sensors or smart devices. Example sensors may be configured to monitor or sense environmental changes.

As used herein, the term “environmental responsive dye” or “sensing element” refers to a ink composition that is imbued with chemical-physical sensing properties, where the sensing element may be configured to alter chemical-physical state (e.g., change color) or generate an output (e.g., signal) in response to changes in one or more environmental parameter (e.g., temperature, pressure, concentration, light, pH, force, humidity, current, voltage). Non-limiting examples include a pH change induced by contacting sweat, rain, or gas pollution to the environmental stimuli sensor. Other environmental stimuli may include temperature, pressure, or the ability to sense concentrations of compounds or moieties, such as contaminants, bacteria, or toxins. In some embodiments, the sensor may be configured to generate an output indicative of the change in the one or more environmental parameter, which may be relayed to a processor for further processing (e.g., via connectors, fabric circuits, interconnects).

Apparatus, devices, and/or objects are or can be used for production of wearable devices. Applications range in scale from fashion accessories, technical apparel, lightweight furniture, tensile canopies, and architectural wall paper or façade components.

### Ink Compositions:

In some embodiments, the biologically-based ink compositions provided herein comprise at least one biologically-compatible polymer and a solvent or dispersing medium.

In some embodiments, suitable biologically-compatible biopolymers for use in accordance with the present disclosure include a polypeptide, fragment or variant thereof. In some embodiments, useful polypeptides include, for example, actins, collagens, catenins, claudins, coilins, elastins, elaunins, extensins, fibrillins, fibroins, keratins, lamins, laminins, silks, silk fibroin, structural proteins, tublins, zein proteins and combinations thereof. Ink compositions may contain at least one biologically-compatible polymer, or at least two biologically-compatible polymers, or at least three, or at least four, or at least 5, to less than 6, or less than 7, or less than 8, or less than 9, or less than 10 biologically-compatible polymers.

In some embodiments, the biologically-based ink compositions are provided, prepared, and/or manufactured from a polypeptide solution, such as a silk fibroin solution, from about 0.5 wt % polypeptide to about 30 wt % polypeptide (e.g., about 0.5 wt % polypeptide, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt % about, 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % polypeptide).

In some embodiments, the polypeptide constitutes from 10 wt % to 70 wt % of the total solid content in the biologically-based ink composition. In some embodiments, the polypeptide constitutes at least 10 wt %, or at least 20 wt %, at least 30 wt %, at least 35 wt %, at least 40 wt %, at least 45 wt %, to less than 50 wt %, or less than 55 wt %, less than 60 wt %, less than 65 wt %, or less than 70 wt %, based on the total solid content in the biologically-based ink composition.

In some embodiments, the biologically-based ink composition are provided, prepared, and/or manufactured from a solvent or dispersing medium that comprises an aqueous solution of polypeptide. In some embodiments, the solvent or dispersing medium comprises water, PBS, and combinations thereof.

In some embodiments, the biologically-based ink composition includes one or more polypeptide, fragment or variant thereof, where silk fibroin constitutes a percentage of a total polypeptide weight in the biologically-based ink composition. In some embodiments, silk fibroin constitutes 100% of the polypeptides in the ink composition, or less than 50%, less than 40%, less than 30%, less than 20%, less than 10%, less than 9%, less than 8%, less than 7%, less than 6%, less than 5%, less than 4%, less than 3%, to less than 2%, based on the total polypeptides in the ink composition.

As used herein, the term “silk fibroin” refers to silk fibroin protein whether produced by silkworm, spider, or other insect, or otherwise generated (Lucas et al., Adv. Protein Chem., 13:107-242 (1958)). Any type of silk fibroin can be used in different embodiments described herein. Silk fibroin produced by silkworms, such as Bombyx mori, is the most common and represents an earth-friendly, renewable resource. For instance, silk fibroin used in a silk film may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants, and variants thereof, that can be used. See, e.g., WO 97/08315 and U.S. Pat. No. 5,245,012, each of which is incorporated herein as reference in its entirety.

In some embodiments, silk fibroin solution can be prepared by any conventional method known to one skilled in the art. In some embodiments, a silk solution is an aqueous silk solution. In some embodiments, silk polypeptide compositions utilized in accordance with the present invention are substantially free of sericins (e.g., contain no detectable sericin or contain sericin at a level that one of ordinary skill in the pertinent art will consider negligible for a particular use).

For example, B. mori cocoons are boiled for about 30 minutes in an aqueous solution. In some embodiments, the aqueous solution is about 0.02M Na₂CO₃. In some embodiments, boiling (degumming) time is in a range of about 5 minutes to about 120 minutes. In some embodiments, boiling (degumming) temperature is in a range of about 30° C. to about 120° C. In some embodiments, boiling (degumming) may occur under pressure. For example, suitable pressures under which protein fragments can be produced may range between about 10 to 40 psi.

The cocoons may be rinsed, for example, with water to extract the sericin proteins and the extracted silk is dissolved in an aqueous salt solution. Exemplary salts useful for this purpose include lithium bromide, lithium thiocyanate, calcium nitrate or other chemicals capable of solubilizing silk. Preferably, in some embodiments, the extracted silk is dissolved in about 9-12 M LiBr solution. The salt is consequently removed using, for example, dialysis.

### Surfactants:

In some embodiments, the biologically-based ink composition may contain a surfactant. The surfactant may be present in the ink composition in an amount sufficient to induce the formation of a silk fibroin matrix (e.g., hydrogel). The formation of the silk fibroin matrix may be induced using a cationic surfactant or an anionic surfactant.

Surprisingly and unexpectedly, the cationic surfactant and polypeptide (e.g., silk fibroin) matrix exhibits reduced leaching performance of one or more additive embedded in the matrix. Without being bound to a particular theory, it is contemplated that the charge and hydrophobic alkyl groups of the cationic surfactant lead to the formation of a silk fibroin matrix having a random coil secondary structure. In certain embodiments, the formation of a silk fibroin matrix is beneficial for trapping or entraining one or more additive within the ink composition. For example, the silk fibroin matrix may act as a molecular cage that physically traps one or more additive entrained therein, hampering its leaching to the surrounding environment through charge effects.

In some embodiments, the cationic surfactant comprises an alkyl-amino moiety. Non-limiting examples of cationic surfactants include, but are not limited to, decyl trimethyl ammonium bromide, dodecyl trimethyl ammonium bromide, cetyl trimethyl ammonium bromide, and stearyl trimethyl ammonium bromide. In some embodiments, cetyl trimethyl ammonium bromide is particularly effective for reducing leaching.

In some embodiments, an anionic surfactant may be used in the biologically based ink composition. In some non-limiting examples, the anionic surfactant may be effective for entrapping positively charged additives (e.g., dyes or active agents).

In some embodiments, the surfactant is present at a concentration ranging between about 0.01 to 10% (either by volume or weight percent) of the ink composition. In some embodiments, the biologically-based ink compositions include a surfactant at a concentration of at least 0.1 wt %, at least 0.2 wt %, at least 0.3 wt %, at least 0.4 wt %, at least 0.5 wt %, at least 0.6 wt %, at least 0.7 wt %, at least 0.8 wt %, at least 0.9 wt %, at least 1 wt %, at least 2 wt %, at least 3 wt %, at least 4 wt %, at least 5 wt %, at least 6 wt %, at least 7 wt %, at least 8 wt %, or at least 9 wt %. In some embodiments, the biologically-based ink compositions include a surfactant at a concentration of at most 0.2 wt %, at most 0.3 wt %, at most 0.4 wt %, at most 0.5 wt %, at most 0.6 wt %, at most 0.7 wt %, at most 0.8 wt %, at most 0.9 wt %, at most 1 wt %, at most 2 wt %, at most 3 wt %, at most 4 wt %, at most 5 wt %, at most 6 wt %, at most 7 wt %, at most 8 wt %, at most 9 wt %, or at most 10 wt %.

In some non-limiting examples, a surfactant concentration range of 0.01 to 3% (either by volume or weight percent) may be particularly effective for ink-jet printing. In other non-limiting examples, a surfactant concentration range of 1% to 10% (either by volume or weight percent) may be particularly effective for screen-printing.

In some embodiments, the ink composition comprises cetyl trimethyl ammonium bromide at a concentration of 0.01% to 3% (either by volume or by weight).

In some embodiments, the ink composition includes silk fibroin in a random coil secondary structure. It should be noted that, depending on the molecular environment, silk fibroin may exhibit various secondary structures, such as a random coil arrangement, a helical arrangement, and a beta-sheet arrangement. In some embodiments, the ink composition may contain silk fibroin or a silk fibroin matrix (e.g., a hydrogel) that is in a random coil arrangement or predominantly in a random coil arrangement (e.g., having a content of random coil that is greater than content of beta-sheet and helical individually). In some embodiments, the random coil content may range from about 5% to about 70% (e.g., at least about 5%, at least about 10%, at least about 15%, at least about 20%, at least about 25%, at least about 30%, at least about 35%, at least about 40%, to less than about 45%, or less than about 50%, less than about 55%, less than about 60%, less than about 65%, and less than about 70%). In some embodiments, the amount of cationic surfactant present in the ink composition influences the formation of a random coil arrangement.

In some embodiments, the ink composition includes one or more ionic salt. The ionic salt may be present in the ink composition in at a concentration of 0.1 wt % to 10 wt %. In some embodiments, the ink compositions include an ionic salt at a concentration of at least 0.1 wt %, at least 0.2 wt %, at least 0.3 wt %, at least 0.4 wt %, at least 0.5 wt %, at least 0.6 wt %, at least 0.7 wt %, at least 0.8 wt %, at least 0.9 wt %, at least 1 wt %, at least 2 wt %, at least 3 wt %, at least 4 wt %, at least 5 wt %, at least 6 wt %, at least 7 wt %, at least 8 wt %, or at least 9 wt %. In some embodiments, the sensing element 22 includes an ionic salt at a concentration of at most 0.2 wt %, at most 0.3 wt %, at most 0.4 wt %, at most 0.5 wt %, at most 0.6 wt %, at most 0.7 wt %, at most 0.8 wt %, at most 0.9 wt %, at most 1 wt %, at most 2 wt %, at most 3 wt %, at most 4 wt %, at most 5 wt %, at most 6 wt %, at most 7 wt %, at most 8 wt %, at most 9 wt %, or at most 10 wt %.

In some embodiments, the ink composition is suitable for inkjet printing, screen-printing, spray-coating, and tape layering. The viscosity of the inks may be tuned to printing conditions suitable for each fabrication method. In this regard, the ink composition may also include one or more viscosity-modifying agent or thickening agent. The viscosity-modifying agent or thickening agent may be present in the ink composition in an amount sufficient to increase the viscosity to levels suitable for use in the desired fabrication or printing technique. In some embodiments, the viscosity-modifying agent or thickening agent comprises a natural gum, starch, pectin, agar-agar, gelatin, derivatives and combinations thereof. Non-limiting examples include, but are not limited to, sodium alginate, acrylate esters, acrylic esters, acrylic monomer, aliphatic mono acrylate, aliphatic mono methacrylate, derivatives and combinations thereof.

In some embodiments, the provided ink compositions contain between about 0.1-30%, or about 1.0-25%, or about 5-20% of viscosity modifying agent or thickening agents (measured by volume or by total weight). In some embodiments, the viscosity modifying agent or thickening agent constitutes at least 0.1 wt %, or at least 0.5 wt %, at least 0.6 wt %, at least 0.7 wt %, at least 0.8 wt %, at least 0.9 wt %, at least 1 wt %, at least 1.1 wt %, at least 1.2 wt %, at least 1.3 wt %, at least 1.4 wt %, at least 1.5 wt %, at least 2 wt %, at least 3 wt %, at least 4 wt %, at least 5 wt %, to less than 6 wt %, or less than 7 wt %, less than 8 wt %, less than 9 wt %, or to less than 10 wt %, based on the total weight of the ink composition.

In some embodiments, the viscosity modifying agent or thickening agent provides structure to the cured ink.

In some embodiments, the viscosity modifying agent or thickening agent constitutes from 10 wt % to 70 wt % of the total solid content in the ink composition. In some embodiments, the viscosity modifying agent or thickening agent constitutes at least 10 wt %, or at least 20 wt %, at least 30 wt %, at least 35 wt %, at least 40 wt %, at least 45 wt %, to less than 50 wt %, or less than 55 wt %, less than 60 wt %, less than 65 wt %, or less than 70 wt %, based on the total solid content in the ink composition.

In some embodiments, the viscosity of the inks may be is tuned to the requirements of each fabrication method. The viscosities of the inks used to functionalize surfaces via screen-printing may be in the range 1000-5000 cPs. The viscosities of paste-like inks used to make objects via computer-controlled extrusion systems are in the range of 500 cPs to 50,000 cPs. In contrast, previous inks have had viscosities in the range of 1-20 cPs. n some embodiments, the viscosity of the ink composition may be in the range of 1 to 20 cP, or 1 to 10 cP, or 1 to 5 cP. Different additives may be included in the compositions to achieve these higher viscosities in order to utilize different printing techniques.

In some embodiments, viscosity may be measured by a viscometer or rheometer. Kinematic viscosity may be measured using a glass capillary viscometer. Viscosity may be measured by measuring the efflux time of the composition from a cup such as a Zahn cup or a Ford viscosity cup.

In some embodiments, the ink composition includes one or more plasticizer. In some embodiments, the plasticizer is added to the ink composition to produce or promote plasticity, flexibility, or reduce brittleness. In some embodiments, suitable plasticizers include natural-based plasticizers, such as glycerol. In some embodiments, the plasticizer constitutes from 0.1 wt % to 10 wt %, based on the total weight of the ink composition. In some embodiments, the plasticizer constitutes at least 0.1 wt %, or at least 0.5 wt %, at least 0.6 wt %, at least 0.7 wt %, at least 0.8 wt %, at least 0.9 wt %, at least 1 wt %, at least 1.1 wt %, at least 1.2 wt %, at least 1.3 wt %, at least 1.4 wt %, at least 1.5 wt %, at least 2 wt %, at least 3 wt %, at least 4 wt %, at least 5 wt %, to less than 6 wt %, or less than 7 wt %, less than 8 wt %, less than 9 wt %, or to less than 10 wt %, based on the total weight of the ink composition.

In some embodiments, the thickening agent and the plasticizer are present in the ink composition at a weight ratio (thickeningagent:plasticizer) from 1:1 to 5:1. In some embodiments, the weight ratio of thickening agent to plasticizer is from 1:1 to 2:1, or 3:1, or 4:1, or to 5:1.

In some embodiments, the thickening agent and the at least one polypeptide are present in the ink composition at a weight ratio (thickeningagent:polypeptide) from 1:1 to 5:1. In some embodiments, the weight ratio of thickening agent to polypeptide is from 1:1, or 1.1:1, or 1.2:1, to 1.3:1, or 1.4:1, or 1.5:1, or 2:1, or 3:1, or 4:1, or to 5:1.

In some embodiments, the at least one polypeptide and the plasticizer are present in the ink composition at a weight ratio (polypeptide:plasticizer) from 1:1 to 5:1. In some embodiments, the weight ratio of thickening agent to polypeptide is from 1:1, or 1.1:1, or 1.2:1, 1.3:1, or 1.4:1, to 1.5:1, or 2:1, or 3:1, or 4:1, or to 5:1.

### Additives or Dopants:

In some embodiments, the ink compositions of the present disclosure may include one or more additive or dopant. Typically, the addition of an additive or dopant is said to “functionalize” the ink composition by providing added functionality. Non-limiting examples of suitable additives or dopants include dyes/pigments, conductive or metallic particles, inorganic particles, and biologically active agents (e.g., therapeutic agents, protein fragments or complexes thereof, cells and fractions thereof).

In some embodiments, the sensing elements 22 of the present disclosure includes from 0.1 wt % to 30 wt % of an additive or dopant, based on total weight of the sensing element or on a dry solids basis.

### Dyes/Pigments:

In some embodiments, the ink composition provided herein comprises an organic or an inorganic dye or pigment. In some embodiments, the dye or pigment is added to the ink composition to impart any desired color or grayscale.

In some embodiments the dye or pigment may be environmentally sensitive and may include, but is not limited to, a pH sensitive dye, a thermal sensitive dye, or a pressure sensitive dye. Depending on the surrounding environment and conditions, the environmentally sensitive dyes may alter the ink composition from a first chemical-physical state to second chemical-physical state that is indicative of one or more parameter in the surrounding environment. For example, the ink composition may change color in response to an elevation in temperature, pH, pressure, and/or concentration of a chemical species (e.g., contaminant or toxin).

In some embodiments, the one or more additive or dopant may be entrained within the ink composition such that the ink composition may reversibly transform between chemical-physical states over multiple exposures or cycles. In some embodiments, the ink composition may reversibly transform between chemical-physical states (e.g., undergo color changes) over multiple exposures or cycles without loss of efficacy, without significant loss of efficacy, or without severe loss of efficacy.

In some embodiments, the pH sensitive dye includes, but is not limited to, cresol red, methyl violet, crystal violet, ethyl violet, malachite green, methyl green, 2-(p-dimethylaminophenylazo) pyridine, paramethyl red, metanil yellow, 4-phenylazodiphenylamine, thymol blue, metacresol purple, orange IV, 4-o-Tolylazo-o-toluindine, quinaldine red, 2,4-dinitrophenol, erythrosine disodium salt, benzopurpurine 4B, N,N-dimethyl-p-(m-tolylazo) aniline, p-dimethylaminoazobenene, 4,4′-bis(2-amino-1-naphthylazo)-2,2′-stilbenedisulfonic acid, tetrabromophenolphthalein ethyl ester, bromophenol blue, congo red, methyl orange, ethyl orange, 4-(4-dimethylamino-1-naphylazo)-3-methoxybenesulfonic acid, bromocresol green, resazurin, 4-phenylazo-1-napthylamine, ethyl red 2-([-dimethylaminophenyazo) pyridine, 4-(p-ethoxypehnylazo)-m-phenylene-diamine monohydrochloride, resorcin blue, alizarin red S, methyl red, propyl red, bromocresol purple, chlorophenol red, p-nitrophenol, alizarin 2-(2,4-dinitrophenylazo) 1-napthol-3,6-disulfonic acid, bromothymol blue, 6,8-dinitro-2,4-(1H) quinazolinedione, brilliant yellow, phenol red, neutral red, m-nitrophenol, cresol red, turmeric, metacresol purple, 4,4′-bis(3-amino-1-naphthylazo)-2,2′-stilbenedisulfonic acid, thymol blue, p-naphtholbenzein, phenolphthalein, o-cresolphthalein, ethyl bis(2,4-dimethylphenyl) ethanoate, thymolphthalein, nitrazine yellow, alizarin yellow R, alizarin, p-(2,4-dihydroxyphenylazo) benzenesulfonic acid, 5,5′-indigodisulfonic acid, 2,4,6-trinitrotoluene, 1,3,5-trinitrobenezne, and clayton yellow.

### Biologically Active Agents:

In some embodiments, the additive is a biologically active agent. The term “biologically active agent” as used herein refers to any molecule which exerts at least one biological effect in vivo. For example, the biologically active agent can be a therapeutic agent to treat or prevent a disease state or condition in a subject. Biologically active agents include, without limitation, organic molecules, inorganic materials, proteins, peptides, nucleic acids (e.g., genes, gene fragments, gene regulatory sequences, and antisense molecules), nucleoproteins, polysaccharides, glycoproteins, and lipoproteins. Classes of biologically active compounds that can be incorporated into the composition described herein include, without limitation, anticancer agents, antibiotics, analgesics, anti-inflammatory agents, immunosuppressants, enzyme inhibitors, antihistamines, anti-convulsants, hormones, muscle relaxants, antispasmodics, ophthalmic agents, prostaglandins, anti-depressants, anti-psychotic substances, trophic factors, osteoinductive proteins, growth factors, and vaccines.

In some embodiments, the additive is a therapeutic agent. As used herein, the term “therapeutic agent” means a molecule, group of molecules, complex or substance administered to an organism for diagnostic, therapeutic, preventative medical, or veterinary purposes. As used herein, the term “therapeutic agent” includes a “drug” or a “vaccine.” This term include externally and internally administered topical, localized and systemic human and animal pharmaceuticals, treatments, remedies, nutraceuticals, cosmeceuticals, biologicals, devices, diagnostics and contraceptives, including preparations useful in clinical and veterinary screening, prevention, prophylaxis, healing, wellness, detection, imaging, diagnosis, therapy, surgery, monitoring, cosmetics, prosthetics, forensics and the like. This term can also be used in reference to agriceutical, workplace, military, industrial and environmental therapeutics or remedies comprising selected molecules or selected nucleic acid sequences capable of recognizing cellular receptors, membrane receptors, hormone receptors, therapeutic receptors, microbes, viruses or selected targets comprising or capable of contacting plants, animals and/or humans. This term can also specifically include nucleic acids and compounds comprising nucleic acids that produce a therapeutic effect, for example deoxyribonucleic acid (DNA), ribonucleic acid (RNA), nucleic acid analogues (e.g., locked nucleic acid (LNA), peptide nucleic acid (PNA), xeno nucleic acid (XNA)), or mixtures or combinations thereof, including, for example, DNA nanoplexes, siRNA, microRNA, shRNA, aptamers, ribozymes, decoy nucleic acids, antisense nucleic acids, RNA activators, and the like. Generally, any therapeutic agent can be included in the composition described herein.

The term “therapeutic agent” also includes an agent that is capable of providing a local or systemic biological, physiological, or therapeutic effect in the biological system to which it is applied. For example, the therapeutic agent can act to control infection or inflammation, enhance cell growth and tissue regeneration, control tumor growth, act as an analgesic, promote anti-cell attachment, and enhance bone growth, among other functions. Other suitable therapeutic agents can include anti-viral agents, hormones, antibodies, or therapeutic proteins. Other therapeutic agents include prodrugs, which are agents that are not biologically active when administered but, upon administration to a subject are converted to biologically active agents through metabolism or some other mechanism. Additionally, a silk-based drug delivery composition can contain one therapeutic agent or combinations of two or more therapeutic agents.

A therapeutic agent can include a wide variety of different compounds, including chemical compounds and mixtures of chemical compounds, e.g., small organic or inorganic molecules; saccharines; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; an extract made from biological materials such as bacteria, plants, fungi, or animal cells; animal tissues; naturally occurring or synthetic compositions; and any combinations thereof. In some embodiments, the therapeutic agent is a small molecule.

The amount of remaining additive or dopant may be measured using analytical techniques known to one of ordinary skill in the art, such as, but not limited to, spectroscopy systems (e.g., mass spectroscopy, atomic absorption, atomic emission, UV-VIS, X-ray, Raman), gas chromatography and liquid chromatography systems (e.g, HPLC and solid-phase extraction), process analyzers (e.g., NIR), refractometers, rheometers, viscometers, evaporators, thermal analyzers, and calorimeters.

### Apparatus, Devices, and Substrates:

In some embodiments, the present disclosure provides apparatuses, devices, objects, and/or articles of manufacture having one or more the biologically-based ink composition adhered thereto to form a coating or sensing element. In some embodiments, suitable substrates or articles of manufacture include 2- or 3-dimensional materials, both soft and hard.

In some embodiments, suitable substrates or articles of manufacture include an exterior surface and pores. The ink composition may be deposited onto the exterior surface and into the pores such that the ink composition is adhered or cured onto at least a portion of the exterior surface and pores. In some embodiments, the article of manufacture and/or substrate is characterized by its flexibility such that when the article of manufacture and/or substrate contacts an object it substantially conforms to the object's surface.

Non-limiting examples of useful substrates or articles of manufacture include, but are not limited to: papers, polyimide, polyethylene, latex, nitrile, natural fabric, synthetic fabric, silk fabric, metals, liquid crystal polymer, palladium, glass and other insulators, silicon and other semiconductors, metals, cloth, textiles, fabrics, plastics, biological substrates, such as cells and tissues, protein- or biopolymer-based substrates (e.g., agarose, collagen, gelatin, etc.), wood, ceramic and any combinations thereof. In some example

In some embodiments, apparatus, devices and/or objects include ink compositions printed on substrates or articles of manufacture in a pattern. For example, the printed pattern may be utilized to functionalize the substrate into an environmental stimuli sensor. The environmental stimuli sensor may be configured to alter chemical-physical states (e.g., change color) or generate an output (e.g., signal) in response to changes in one or more environmental parameter (e.g., pH, temperature, pressure, concentration). Non-limiting examples include a pH change induced by contacting sweat, rain, or gas pollution to the environmental stimuli sensor. Other environmental stimuli may include temperature, pressure, or the ability to sense concentrations of compounds or moieties, such as contaminants, bacteria, or toxins. Conductive ink compositions may be used to form printed biosensors. Printed substrates for sensing environmental stimuli may include textiles and wearable apparel such as gloves, furniture, and wall art.

In some embodiments, the ink composition may be adapted to retain at least a portion of the additive relative to its original concentration, which may be which may be measured, for example, over a period of time, after a number of transitions between chemical-physical states, or after a number of wash cycles.

In some embodiments, the ink composition can adapted to retain at least 20% of its original concentration of additive or dopant over a period of time, for example, at least about 30%, at least about 40%, at least about 50%, at least about 60%, at least about 70%, at least about 90%, at least about 95% of its original concentration of additive or dopant, or higher. In some embodiments, the period of time may be weeks, months, or years. In some non-limiting examples, the period of time may be at least about 1 week, at least about 2 weeks, at least about 3 weeks, at least about 4 weeks, at least about 5 weeks, at least about 6 weeks, at least about 8 weeks, at least about 3 months, at least about 4 months, at least about 5 months, at least about 6 months, at least about 7 months, at least about 8 months, at least about 9 months, at least about 10 months, at least about 11 months, at least about 1 year, at least about 2 years, at least about 3 years, at least about 4 years, at least about 5 years, or longer.

In some embodiments, the ink composition can adapted to retain at least 20% of its original concentration of additive or dopant after a number of transitions between chemical-physical states, for example, at least about 30%, at least about 40%, at least about 50%, at least about 60%, at least about 70%, at least about 90%, at least about 95% of its original concentration of additive or dopant, or higher. As used herein, “transition” or “change” between chemical-physical states may refer to a measurable or observable change in the ink composition in response to a change in one or more environmental parameter. In some embodiments, the ink composition can be adapted to retain the fraction of additive or dopant after at least 2 transitions or changes between chemical-physical states, including, for example at least 3, at least 4, at least 5, at least 6, at least 7, at least 8, at least 9, at least 10, at least 20, at least 30, at least 40, at least 50, at least 100, at least 200, at least 300, at least 400, at least 500, at least 1000, or more transitions or changes between chemical-physical states.

As an illustrative example, a pH sensor comprising the ink composition may be adapted to retain the fraction of additive or dopant after a number of transitions between a first color or grayscale to a second color or grayscale, or other color or grayscale. This may occur, for example, by exposing the pH sensor to different pH solutions or environments for a duration (e.g., 30 seconds, 1 minute, 5 minutes, 10 minutes, 30 minutes, 60 minutes, or more). For example, the pH sensor may be submerged or exposed to an acidic solution (e.g., pH of 4) for a first time to induce a first transition to a first color. The pH sensor may then be transferred to a basic solution (e.g., pH of 10) for a second time to induce a second transition to a second color, and optionally dried in-between. This process may be repeated for a desired number of transitions and the amount of remaining additive or dopant may be measured to determine the amount of additive retained by the pH sensor.

The amount of remaining additive or dopant may be measured using analytical techniques known to one of ordinary skill in the art, such as, but not limited to, spectroscopy systems (e.g., mass spectroscopy, atomic absorption, atomic emission, UV-VIS, X-ray, Raman), gas chromatography and liquid chromatography systems (e.g, HPLC and solid-phase extraction), process analyzers (e.g., NIR), refractometers, rheometers, viscometers, evaporators, thermal analyzers, and calorimeters.

In some embodiments, the term “a wash cycle” may refer to submerging or exposing the article of manufacture and/or substrate to a solution or solvent for a duration, and subsequently removing the article from the solution or solvent. In some embodiments, the ink composition can adapted to retain at least 20% of its original concentration of additive or dopant after a number of wash cycles, for example, at least about 30%, at least about 40%, at least about 50%, at least about 60%, at least about 70%, at least about 90%, at least about 95% of its original concentration of additive or dopant, or higher. In some embodiments, the ink composition can be adapted to retain the fraction of additive or dopant after at least 1 wash cycle, including, for example at least 2 wash cycles, at least 3 wash cycles, at least 4 wash cycles, at least 5 wash cycles, at least 6 wash cycles, at least 7 wash cycles, at least 8 wash cycles, at least 9 wash cycles, at least 10 wash cycles, at least 20 wash cycles, at least 30 wash cycles, at least 40 wash cycles, at least 50 wash cycles, at least 100 wash cycles, or more.

In some embodiments, the solution or solvent for the wash cycle may comprise commercially available laundry detergent or commercially available dry cleaning solution. In some embodiments, the solution comprises water, acidic water, or basic water. In some embodiments the wash cycle includes washing the article and ink composition in a commercially available washing machine accompanied by drying in a commercially available dryer. Washing and subsequent measurement, such as colorfastness, may be performed in accordance with various American Association of Textile Chemists and Colorists (AATCC) standards, such as AATCC 61-1996.

In some embodiments, the environmental sensors disclosed herein offer improved resistance to leaching the additive or dopant to the surrounding environment, especially when exposed or submerged within a solvent, such as basic or acidic aqueous solutions.

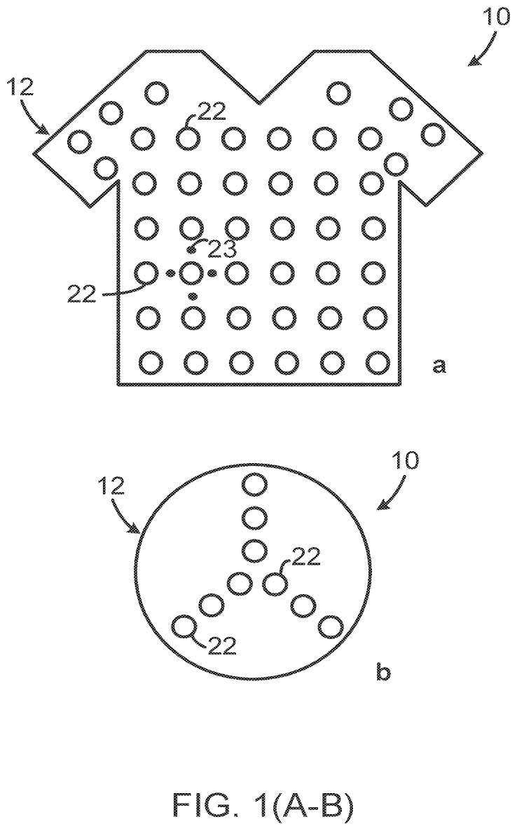

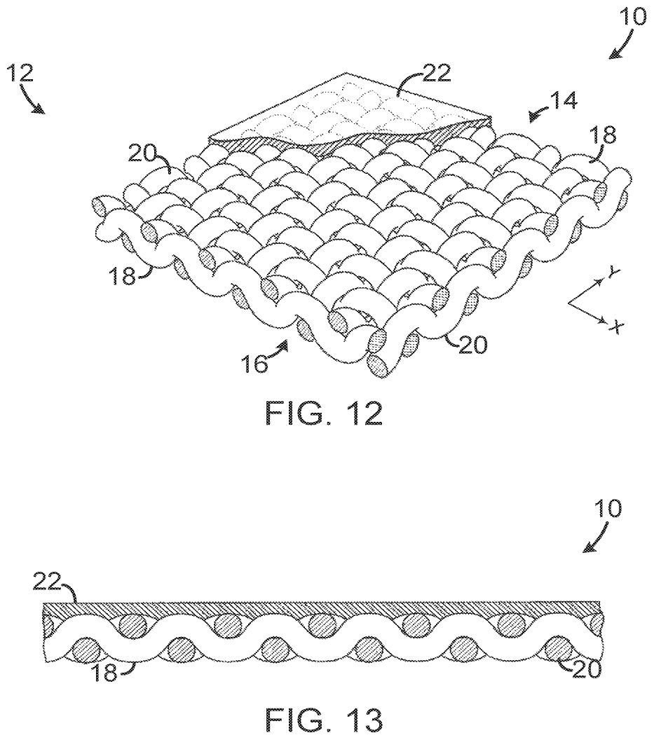

Referring to the drawings, and specifically to FIGS. 1 and 12-13, a coated article is shown and indicated generally by the reference numeral 10. The coated article 10 includes a substrate and/or article of manufacture 12 that forms a body having a geometric shape. The substrate 12 includes a coating 22 that forms a pattern across a surface of the substrate 12. In some embodiments, the coating 22 forms a sensing element including at least one biopolymer and a sensing additive.

In some embodiments, the substrate 12 optionally includes a reference indicia 23. In some embodiments, the reference indicia 23 has a chemical-physical state that remains unchanged under various conditions, and can be used during real-time monitoring or data processing as a reference parameter to track changes from the sensing element 22. The color of the reference indicia 23 may be used in image processing (e.g., Nuance software) to facilitate tracking changes over time of the sensing element 22.

As used herein, the term “geometric shape” may refer to a three dimensional shape or configuration having a length, a width, and a height. The geometric shape can be formed from straight edges or curves to form “regular” shapes including, but not limited to, cubes, prisms, spheres, cones, cylinders. The three dimensional shape may also be “irregular” shapes having edges, sides, or curves that vary throughout the length, width, and height of the coated article 10.

### Substrate:

In some embodiments, the substrate 12 is a material including, but not limited to, a metal, a polymer, a ceramic, or a composite. Non-limiting example substrates 12 include fabrics, woods, plastics, papers, leathers, metals, stones, concretes, rubbers, glasses, paints, semiconductors, plasters, and foams. In some embodiments, the substrate 12 may have a porous surface or a non-porous surface. In some embodiments, the substrate 12 may be hydrophobic or hydrophilic. In some embodiments, the substrate 12 may be deformable or rigid. As shown in FIG. 1A, the substrate 12 may be an article of clothing, such as a t-shirt. As shown in FIG. 1B, the substrate 12 may be a patch of fabric.

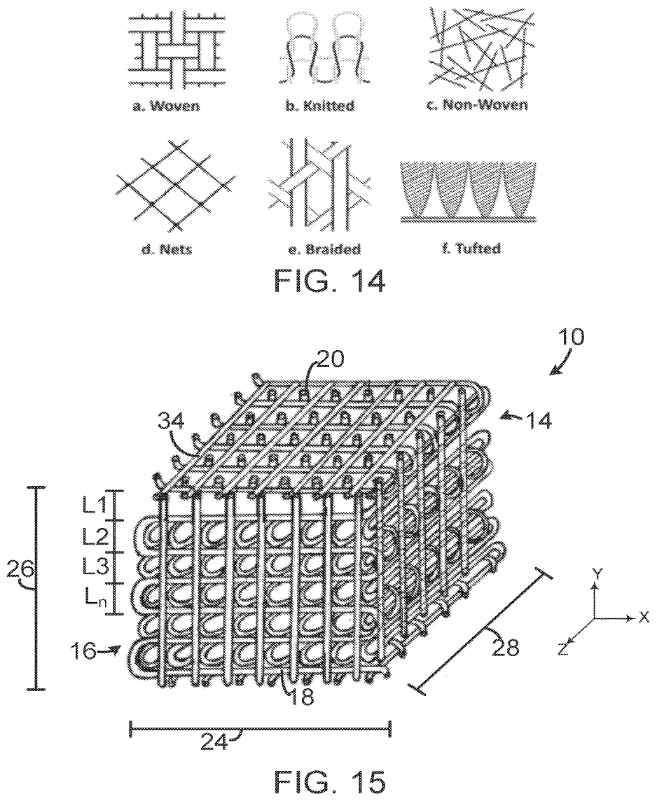

In some embodiments, the substrate 12 forms a three-dimensional hierarchical body 10 having a first end on a first surface 14 and an opposing second end on an opposing second surface 16 of the body 10. In some embodiments, the three-dimensional hierarchical body 10 is a fabric composed of a plurality of entangled fibers, such as an axial fiber 18 and a longitudinal fiber 20. Referring to FIG. 14, the term “entangled fibers,” as used herein, may refer to a fabric structure including, but is not limited to: woven 3a, knitted 3b, non-woven 3c, nets 3d, braided 3e, and tufted 3f arrangements. These structural motifs may be repeated through a plurality of layers (e.g., 2 layers, 5 layers, 10 layers, 100 layers, etc.) to form the three-dimensional hierarchical body 10, as shown in FIG. 15.

Referring to FIG. 15, the three-dimensional hierarchical body 10 may include a width 24, a length 26, and a height or thickness 28. In some embodiments, the body 10 is composed of a multitude of axial fibers 18 and longitudinal fibers 20. The axial fibers 18 extend transversely along the width 24 of the body 10, and the longitudinal fibers 20 extend vertically along the length 26 of the body 10. The body 10 may further include filling fibers 34 inserted between rows of axial fibers 18. Woven fabrics are typically constructed from substantially straight interconnections of wefts (axial fibers 18) and warps (longitudinal fibers 20), and knits are typically made of looped interconnections of courses (axial fibers 18) and wales (longitudinal fibers 20).

In some embodiments, the hierarchical body 10 includes a plurality of layers 36. The layers 36 may be defined by a distance (e.g., L1, L2, L3) between adjacent axial fibers 18 or longitudinal fibers 20 extending through the hierarchical body 10. In some embodiments, the plurality of layers 36 includes a first layer L1, a second layer L2, and a third layer L3. The number of layers may range from 1 to 100, or more. In some embodiments, the hierarchical body 10 includes at least one layer, or at least two layers, or at least three layers, at least four layers, at least five layers, at least six layers, at least seven layers, at least eight layers, at least nine layers, or at least ten layers. In some embodiments, the hierarchical body 10 includes at most 20 layers, at most 30 layers, at most 40 layers, at most 50 layers, at most 60 layers, at most 70 layers, at most 80 layers, at most 90 layers, or at most 100 layers.

### Coating/Sensing Element:

In some embodiments, the substrate 12 includes a coating 22 that forms a pattern on a surface of the substrate 12. The pattern may be used to functionalize the substrate 12 into a sensing element 22.

The sensing elements 22 described herein may be used for production of wearable devices. Applications range in scale from fashion accessories, technical apparel, lightweight furniture, tensile canopies, and architectural wall paper or façade components.

In some embodiments, the substrate 12 includes a single sensing element 22 in contact with a surface of the substrate 12. In some embodiments, the substrate 12 includes an array of sensing elements 22. In some embodiments, the array of sensing elements 22 includes from 2 to 1000 sensing elements 22. In some embodiments, the array of sensing elements 22 includes at least two sensing elements 22, or at least three, or at least four, or at least five, or at least six, or at least seven, or at least eight, or at least nine, or at least ten, or at least 20, or at least 30, or at least 40, to at least 50 sensing elements. In some embodiments, the array of sensing elements 22 includes less than 60 sensing elements, or less than 70, or less than 80, or less than 90, less than 100 sensing elements 22, less than 200, less than 300, less than 400, less than 500, less than 600, less than 700, less than 800, less than 900, to less than 1000 sensing elements 22.

In some embodiments, each sensing element 22 in the array may be spaced from each respective sensing element 22 such that the sensing elements 22 are not in direct contact. In some embodiments, any number of the aforementioned sensing elements 22 may be in direct contact with one another. The composition of the sensing elements 22 may each be the same or different.

In some embodiments, the spacing between adjacent sensing elements 22 may be at least 1 μm to 100 cm. In some embodiments, the spacing between adjacent sensing elements 22 is at least 100 μm, or at least 200 μm, or at least 300 μm, or at least 400 μm, or at least 500 μm, or at least 600 μm, or at least 700 μm, or at least 800 μm, or at least 900 μm, or at least 1 mm, to less than 2 mm, or less than 3 mm, or less than 4 mm, or less than 5 mm, or less than 6 mm, or less than 7 mm, or less than 8 mm, or less than 9 mm, or less than 1 cm, or less than 50 cm, or less than 100 cm.

In some embodiments, the sensing element or the array of sensing elements 22 may be in contact with a plurality of layers in the three dimensional hierarchical body 10. For example, the sensing element 22 may be in contact with at least a portion of the entangled fibers in the first layer L1. In some embodiments, the sensing element 22 may extend into the body 10 be in contact with at least a portion of the entangled fibers in the first layer to the 20th layer of the body 10. For example, the sensing element 22 may extend into the body 10 to contact at least the first layer L1, or at least the second layer L2, or at least the third layer L3, or at least a fourth layer, or at least a fifth layer, or at least a sixth layer, or at least a seventh layer, or at least an eight layer, or at least a ninth layer, or to at least a tenth layer, where the layers are defined with respect to an external surface of the body 10. In some embodiments, the sensing element may extend into the body to contact at most 11 layers, or at most 12 layers, or at most 13 layers, or at most 14 layers, or at most 15 layers, or at most 16 layers, or at most 17 layers, or at most 18 layers, or at most 19 layers, or at most 20 layers. In some embodiments, the sensing element or array of sensing elements 22 partially contacts the entangled fibers in the layers, while in other embodiments the sensing element 22 completely surrounds the entangled fibers in the respective layers.

In some embodiments, the sensing element or array of sensing elements 22 extends into the body 10 with respect to an external surface to contact the entangled fibers along at least 1% of the height or thickness of the body 10. In some embodiments, the sensing element or array of sensing elements 22 extends into the body 10 with respect to an external surface to contact the entangled fibers along at least 2%, or at least 3%, or at least 4%, or to at least 5% of the height or thickness of the body 10. In some embodiments, the sensing element or array of sensing elements 22 extends into the body 10 with respect to an external surface to contact the entangled fibers along at most 6%, or at most 7%, or at most 8%, or at most 9%, or at most 10%, or at most 15%, to at most 20% of the height or thickness of the body 10.

In some embodiments, multiple sensing elements 22 may be arranged on multiple surfaces of the body 10. For example, a first sensing element 22 may be in contact with a first surface 14 of the body 10, and a second sensing element 22 may be in contact with a second surface 16 of the body 10. In some embodiments, a sensing element or an array of sensing elements 22 is configured on at least one surface of the body 10, or at least two surfaces, or at least three surfaces, or to at least four surfaces of the body 10.

In some embodiments, the biopolymer is present in the sensing element 22 in an amount from 30 wt % to 70 wt %, based on the total weight of the sensing element.

In some embodiments, the coating or sensing element 22 comprises the components of the biologically-based ink composition described herein. The terms “biologically-based ink composition” and “ink composition” are used interchangeably herein. In some embodiments, the biologically-based ink composition cures to form the sensing element 22.

The articles, compositions, and methods described herein can be implemented in a variety of ways. The following disclosure is intended to describe uses of the articles and compositions described herein. Each of the uses described below can be implemented with the articles and compositions described above, unless explicitly stated otherwise.

### Interior Aesthetic Fabrics

In one aspect, the articles are curtains, drapery, or other window dressings, wall-hangings, upholsteries, floor coverings (e.g., rugs or carpets), or other fabric-based interior design pieces. The articles can have an aesthetic design printed on one or both surfaces. The aesthetic design can be partially or entirely printed from inks including sensing elements as described herein.

In one particular case, these interior aesthetic fabrics (and the other end-uses described herein) can be designed to have a visually-identifiable change in response to sensing a given condition. For example, an aesthetic design of a floral arrangement can have static colors for the majority of the design with the exception of the floral petals. The floral petals can be printed with the compositions described herein, including one or more sensing elements. The chemistry of the floral petals can be adapted to provide a first color when experiencing a neutral or baseline chemical environment and a second color when experiencing a chemical environment that is intended to be sensed. The color change in these cases need to be significant enough to be detectable by the naked eye. When a user observes that the color of the floral petals has changed from the first color to the second color, they can determine that the analyte of interest is present at the location of the sensing element.

In another particular case, these interior aesthetic fabrics (and the other end-uses described herein) can be designed to have a visually-unidentifiable, but spectroscopically identifiable, change in response to sensing a given condition. Using the floral petal example from the preceding paragraph, in this case, the floral petals would not change color to the naked eye, but spectroscopic interrogation of the floral petals would reveal whether the analyte of interest is present or not.

In one specific example, the interior aesthetic fabric can have sensing elements that are adapted to sense environmental contaminants, such as chemicals associated with poor air quality. In these cases, the fabrics can be deployed in locations that have environmental air filters. When the filters function properly, no contaminants are allowed into the space to prompt a change in the sensing elements. When the filters are not functioning properly, contaminants enter the space and prompt a change in the sensing elements. A user observing the fabric can have a visual queue to replace the air filter. Similarly, the fabrics can be deployed in a “clean room” environment, where the sensing elements will preferably be extremely sensitive to contaminants.

### Medical Applications

In one specific application, the fabric-based interior design pieces are deployed in a medical environment. Medical curtains are conventionally utilized for separating larger spaces into smaller divided spaces and providing visual privacy for patients. When adapted to utilize the sensing elements of the present disclosure, the curtains can be utilized as environmental sensors.

The articles described herein can have unique codes affixed to one or more surfaces in order to facilitate identification of the article. The unique codes can be a bar code, including one-dimensional bar codes, 2-dimensioncal bar codes, and the like. predetermined, pseudorandomly- or randomly-generated number and/or character strings, or other unique codes known to those having ordinary skill in the coding arts. In some cases, the unique codes are themselves composed of sensing elements.

When utilized in a medical context, the unique codes can be scanned in a similar fashion to bar codes on patient wristbands and medicine containers. The unique code can be scanned and medical information software can process the use of the particular article to which the unique code is associate. Once identified and activated, the article can be manually monitored (e.g., by providing a notification to a medical professional that a certain sensor signal is representative of a given condition) or automatically monitored (e.g., by spectroscopically monitoring the article to automatically sense an environmental condition to which the article is designed to be sensitive).

When the unique codes themselves include or are composed entirely of sensing elements, the sensing elements can work together in concert to provide a unique code upon sensing one or more analytes of interest. Alternatively, the sensing elements can work together such that the unique code disappears upon sensing one or more analytes of interest.

Given the sensitivity around patient information and the need for confidentiality within the medical field, articles that are utilized in the medical context can be deployed within a broader system that maintains the anonymity of individuals within a space while monitoring the sensing elements within that space. In one case, very low resolution cameras or even single pixel diodes can be utilized to monitor the color of sensing elements within a medical space. In some cases, passive monitoring can be done with anonymous sensing means such as these can be used as a prompt for an employee to go to a given medical space for a more detailed reading of the sensing elements within that space.

As one example, a medical space can be defined by a single flat wall and a curtain or multiple curtains that surround the space (i.e., the wall takes up 90° of the space and the curtain(s) take up 270° of the space). A single-pixel color sensor can be set up to monitor the average color of the space. If the average color of the space changes by a predetermined amount, a signal can be sent to a medical care giver to prompt a more specific reading. Upon receiving that signal, a medical care giver can enter the space with a hand-held or otherwise portable sensing apparatus to take a more detailed reading of the sensing element(s).

In some particular cases in the medical environment, it can be useful to utilize the visually-identifiable changes discussed above in the context of the interior aesthetic fabrics. One non-limiting example is a quarantine situation where one or more patients are being quarantined because of suspected exposure to a given chemical or biological contaminant. The patient might undergo unneeded stress if they were to become aware of possible contamination, so the sensing element can be arranged to provide a subtle change to a visual scene. For example, a multi-color striped pattern could be configured so that the third stripe from the top changes color upon contamination. The medical professional that is serving the patient is aware to observe the third stripe from the top for potential contamination, but the patient need not be aware that this color change is indicative of a contamination. Similarly, a subtle color change that can be only measured by spectroscopic means can provide a similar concealment of the information that the sensor is providing.

In some cases, a sensing array can be printed onto a disposable substrate (e.g., a basic paper substrate) and this printed sensing array can be deployed to the location where it is needed. With this approach, a single piece of paper can be clipped or otherwise mounted within a patient's room and can include all of the environmental sensing that is desired for that given patient. As such, a method of personalizing a sensor array is discloses. This method includes: a) selecting a set of sensing chemistries for a given patient; and b) printing the sensing array. The selecting can be done by individually choosing which sensing chemistries are to be included. Alternatively, the selecting can be automated to select chemistries based on a given diagnosis or based on a patient's medical history.

The method of personalizing the sensor array can also include building a layout for the individual chemistries within the array. With this degree of individualization, a memory stores the layout of the array, so that the sensing can recall that layout to make sense of what is being detected.

Alternatively, the method of personalizing the sensor array can include some characteristic symbol associated with a given sensing element, so that the sensing element can be identified without necessarily knowing the layout of the array.

### Clothing-Real Time Monitoring

In one aspect, the articles are articles of clothing that are intended to contact a subject's bodily fluids, such as sweat, urine, and the like. When deployed in this fashion, the sensing elements within the articles of clothing can provide a real-time output of the local chemistry. The article of clothing can include a shirt, pants, a hat, a glove, a sock, shoes, undergarments, a facemask, a compression sleeve, a scarf, or other articles of clothing known to at least occasionally come into contact with biological fluids. In some cases, the clothing can also be adapted for measuring the gaseous environment, though aspects relating to this are discussed in greater detail elsewhere herein.

In one aspect, the chemistry of the sensing elements can be measured by acquiring an optical image of the article. Because images can be acquired in a variety of lighting conditions and with a variety of imaging devices, it can be useful in some cases to include color standards within the article. For example, an article of clothing can have a baseline color that is given by a standard dye and that baseline color can serve as the color correction standard for monitoring a sensing element that is printed onto the fabric. As another example, the article of clothing could have printed areas of a known color in close proximity to each of the sensing elements.

In some cases, in an effort to reduce false positives, the clothing can include a sensor for confirming that the sensing elements are actually in contact with a biological fluid of interest. For example, an array of sensing elements could include alternating sensing elements, where half of the elements change color when contacted by water or aqueous solution and the other half of the elements are intercollated between those elements and include sensing capabilities for one or more analytes of interest.

In one particular example of a clothing embodiment, the piece of clothing can be printed with sensing elements that are sensitive to a metabolite of a performance enhancing drug. This clothing can be mandated by a sport governing body and a positive test could trigger further drug testing for an athlete.

In a similar example, the piece of clothing can be printed with sensing elements that are sensitive to a metabolite that is known to be associated with increased chance of injury. In modern sports medicine, the ability to monitor real-time changes in body chemistry is increasingly important. The articles described herein can provide insight in real-time without the need for electronic sensing or wireless communication of data. The sensing elements would most preferably be reversible in this example, though permanent sensing elements could be envisioned for measuring certain metabolites.

In another particular example of a clothing embodiment, the piece of clothing can be printed with sensing elements that are sensitive to contact with an environment associated with a recreational drug (e.g., sensitive to marijuana smoke). In this way, a parent could include such clothing in a child's wardrobe to monitor whether the child has been present in such an environment.

In another specific example of a clothing embodiment, the piece of clothing can be printed with sensing elements that are sensitive to the chemicals associated with human body odor. Given the mind's ability to remove baseline sensory experiences, such as smelling of one's own body odor, it can be challenging to detect one's own smell. An article of clothing having sensing elements at particular body-odor-generating locations can provide a unique tool for an individual to be able to sense their own production of body odor. The article of clothing could be made with multiple sensing elements: a first element that changes color when a concentration of odor-causing chemicals is high enough to be smelled when directly contacting the garment with one's nose; a second element that changes color when a concentration of odor-causing chemicals is high enough to be smelled when one's nose is at a first distance from the garment; a third element for a concentration high enough to be smelled when one's nose is at a second, greater distance from the garment; and so on with as many different levels of sensitivity as desired. A color scheme that mimics a tachometer could be deployed, where green relates to modest odor, yellow relates to more odor, and red relates to the highest detectable levels of odor.

In a similar, related example, the same sensing capabilities can be utilized in the context of romantic matchmaking. It is believed that this is related to immune system compatibility. The current state of the art in this area is to have an individual sweat into an article of clothing and then have potential mates smell that article of clothing to determine how appealing or unappealing the odor is. An article of clothing that can show these unique olfactory markers would provide a much more pleasant way of making such a determination by replacing the act of smelling a sweaty article of clothing with a visual indicator of which markers are present and/or absent.

### Coating Compositions/Paints

In one aspect, the compositions can be utilized as coating compositions for interior surfaces, such as interior paints.

The sensing elements can be reversible sensors (i.e., when the chemical condition that triggers the sensor is no longer present, the sensor returns to its original state from its altered state) or permanent sensors (i.e., when the chemical condition that triggers the sensor is no longer present, the sensor does not return to its original state and remains in its altered state). In addition, the sensing elements can behave in a quantized fashion (e.g., a binary “on/off” sensor, a tertiary sensor with a baseline state and two active sensing states, a quaternary sensor with a baseline state and three active sensing states, and so on) or in a gradient fashion (e.g., a low concentration of the analyte of interest provides a change that is lesser in degree from a higher concentration of the analyte of interest). These particularities are discussed in detail in this section relating to coating compositions and paints, but are applicable to the other uses described herein unless explicitly stated otherwise.

Generally, reversible sensors will be most preferably utilized in paints for monitoring environmental conditions that are not dangerous. For example, a reversible sensing element can be included in paints for sensing the humidity of a space.

In some cases when using reversible sensors, the sensing element can automatically be reversed by removal of the analyte of interest. In other cases when using reversible sensors, the sensing element can require application of a reversal composition to reset the sensing element.

Generally, permanent sensors will be most preferably utilized in paints for monitoring environmental conditions that are potentially dangerous. For example, a permanent sensing element can be included in paints for sensing carbon monoxide.

In one specific example, the paints described herein can be used to monitor a controlled environment, such as a dry aging room for producing dry-aged beef. In this kind of environment, it can be advantageous to have a biopolymer-based paint. In this particular exemplary environment, the controls that are needed include humidity control and preventing external biological contamination. One portion of the room can be painted with a coating that is sensitive to humidity. Another portion of the room can be painted with a coating that is sensitive to biological contamination.

In another specific example, the paints described herein can be utilized in a controlled indoor agricultural environment for maintaining proper temperature, humidity, and other environmental conditions necessary for the growth of a given species of plant.

In certain cases, the paint may be utilized along with non-sensing paint in a fashion where the absence of an analyte of interest shows a single color for the sensing paint and the non-sensing paint, while the presence of the analyte of interest changes the color of the sensing paint. In these cases, the pattern used for the sensing paint can be selected to convey a given message. For example, when the sensing paint is sensing for a contaminant, the pattern can be the word “CONTAMINATED”, which would then appear when the presence of the contaminant is sensed due to the color change. As another example, when the sensing paint is sensing for a biohazard, the pattern can be the universal symbol for biohazard.

### Combination Delivery/Sensing

In some cases, the inks described herein can include both a deliverable agent (e.g., an active agent, therapeutic, or the like) and a sensing capability.

In one example, a patch can include a printed portion that both releases a therapeutic of interest and also includes a sensing element that is sensitive to a metabolite that is responsive to a condition for which the therapeutic of interest is intended to be effective. This patch can be used with a control patch that includes only the sensing portion of the patch and comparison can be made between the patch and the control patch to determine local efficacy of a given therapeutic.

In another example, an article can be printed with an ink that is adapted to provide controlled release of a perfume or other air freshening scent and a sensing element that is adapted to detect the presence or absence of that perfume or air freshening scent. Rather than rely on one's nose to determine when the air freshener needs to be replaced, this example allows visual inspection to determine when to replace the air freshener. As a specific example, an automotive air freshener can be printed with a sensing element that is sensitive to the scent of the air freshener and which is adapted to change color when the concentration of the scent is below a given threshold.

### Personal Protective Equipment

In one aspect, the articles are pieces of personal protective equipment for a medical professional, such as face masks, gowns, scrubs, shields, glasses, goggles, gloves, respirators, and the like. The sensing capabilities described herein can be utilized to indicate sanitization and/or contamination status of personal protective equipment.

### Wellness and Self Care

In one aspect, the sensing capabilities described herein are utilized for individual wellness, self care, and/or nutritional monitoring.

In one specific aspect, the sensing capabilities described herein are utilized for personal dietary management. One such method involves acquiring an image of a user that is wearing an article of clothing or other article with one or more sensing elements; determining a dietary need for the user; and providing a dietary recommendation to the user.

In one specific aspect, the sensing capabilities described herein are utilized for a daily health certification, which can be used by employers to determine which employees may safely access certain work areas, dependent on their sensed health conditions. One such method involves acquiring an image of an employee that is wearing an article of clothing or other article with one or more sensing elements, determining some physiological condition of the employee based on analysis of the image; and updating the employee's access status based on the physiological condition. In some cases, the method may restrict access to an employee having a given physiological condition.

### Interfacing

In some aspects, the sensing capabilities described herein can be interfaced with conventional diagnostic platforms. A subject undergoing a conventional diagnostic method, such as an MRI, a CT scan, or other diagnostic method, and who is wearing an article of clothing or other article having one or more sensing elements can be visually monitored at the same time as the diagnostic method is being conducted. An exemplary method can include acquiring an image of a subject wearing an article of clothing or other article containing one or more sensing elements while the subject is undergoing a diagnostic method; determining some physiological condition of the subject while undergoing the diagnostic method; making a diagnostic recommendation based on the physiological condition combined with the output of the diagnostic method. For diagnostic methods that involve long acquisition times, these methods could help correct for physiological changes in the subject that occur during acquisition of data for the diagnostic method.

In some aspects, the sensing capabilities described herein can be interfaced with passive circuitry, such as RFID. In some cases, the sensing elements described herein can be part of a passive circuit, where in one sensing condition, the passive circuit takes one form, and in a different sensing condition, the passive circuit takes another form. In the case of RFID, an RFID sensor can be adapted to provide the desired identification signal only in the presence of a predetermined physiological condition.

In some aspects, the sensing capabilities described herein can be interfaced with biometrics systems or bioidentification systems.

In some aspects, the sensing capabilities described herein can be interfaced with cellular phone technologies. The image acquisition capability of a cellular phone provides users with the capability to implement the sensing capabilities described herein at point of use.

In some aspects, the sensing capabilities described herein can be interfaced with data analytics applications. The sensed data described herein can be integrated into big data analysis in ways understood to data scientists having ordinary skill in the art.

In one particular aspect, a smart phone implementation of the sensing capabilities described herein can utilize geo-tracking to monitor movements of individuals that have exhibited a certain physiological condition or individuals who have encountered a given physiological environment. As an example, attendees at a music festival can take pictures which can be scanned for environmental sensing elements, such as those described elsewhere herein. Those images can be analyzed and users that encountered environmental sensing elements that indicated the presence or absence of an analyte of interest can be isolated from the other users. Then, the movement of that subset of users can be tracked in order to provide an indication of the distribution of individuals that encountered the presence or absence of the analyte of interest.

It should be appreciated that these interfacial technologies can be combined with one another and/or with the other approaches described herein, unless the context clearly dictates otherwise.

### Method of Making the Sensing Device:

In some embodiments, a method of manufacturing the sensing device includes depositing a layer of biologically-compatible biopolymer solution, such as silk fibroin solution, on a surface of an article of manufacture and/or substrate. In some embodiments, multiple layers of the biologically-compatible biopolymer solution may be deposited on the surface, such as 2 layers, 3 layers, 4 layers, 5 layers, 10 layers, 20 layers, or more. In some embodiments, the biologically-compatible biopolymer solution includes one or more additive or dopant described herein. Alternatively, the biologically-compatible biopolymer solution may be substantially free of one or more additive or dopant described herein. In some embodiments, the biologically-compatible biopolymer solution is cured and adhered to the article of manufacture and/or substrate. Depositing the biologically-compatible biopolymer may be performed using a number of printing techniques including, without limitation, inkjet printing, reactive inkjet printing, electrohydrodynamic jet printing (EHJP), extrusion-based printing, and spray coating.

In some embodiments, inkjet printing (IJP) is used to deposit the biologically-compatible biopolymer onto the article of manufacture and/or substrate. IJP is an easy, inexpensive and widely accessible technology spread around the world for several decades. The fortune of IJP is tied to the pervasiveness of personal computing, as for the last two decades it has represented one of the fundamental accessories for any PC workstation. IJP is based on the use of electrical actuators to eject picoliter (pL) volumes of liquid from micrometer-wide nozzles onto a substrate in a defined pattern. IJP has gained extensive acceptance in microfabrication for basic patterning and rapid fabrication. While the most popular purpose of IJP technology remains printing paper documents, it has also been applied in organic electronics, chemical synthesis, sensor fabrication, combinatorial chemistry and biology.

Inkjet printing can be divided into two categories: (1) drop-on-demand (DoD) or impulse inkjet, where droplets are generated when required; and (2) continuous inkjet, in which droplets are deflected from a continuous stream to a substrate when needed. Inkjet printing can be further subdivided according to the specific means of generating droplets, such as piezoelectric, thermal and electrostatic. Each of these techniques has specific ranges of operation that limit their applicability. Such variables include: operating temperature range, material throughput, reproducibility of droplets, precision of deposition, range of printable viscosities, range of shear forces within the nozzle, reservoir volume and the number of fluids that may be printed during at the same time. Droplet size involves, typically, volumes ranging from 1.5 pL to 5 nL at a rate of 0-25 kHz for drop-on-demand printers (and up to 1 MHz for continuous printheads).

In some embodiments, reactive inkjet printing (RIJ) printing is used to deposit the biologically-compatible biopolymer on the surface of the article. Reactive inkjet printing may include a two-step process that first deposits a layer or multiple layers of biopolymer solution on the surface. Following deposition of the biopolymer solution, one or more reactive reagent may be deposited onto the biopolymer solution to induce a reaction. For example, a surfactant may be deposited onto the layer of the biologically-compatible biopolymer solution in an amount sufficient to induce the biologically-compatible biopolymer to transform into a biopolymeric matrix (e.g., hydrogel). The biopolymeric matrix may then be cured and adhered to the article of manufacture and/or substrate. The one or more additive or dopant described herein may be deposited with the surfactant or the biopolymer solution.

Electrohydrodynamic jet printing (EHJP) may be utilized to deposit the biopolymer solution to the article. EHJP can produce features as small as 1 μm wide lines, which is typically an order of magnitude smaller than inkjet printing. Naturally, the droplets produced by this technique are also smaller, being in the femto-liter region. Such small droplet sizes are of interest since this means that less material can be dispensed with more spatial control, which couples with the ongoing miniaturization seen in many applications. An open question to be addressed is whether the EHJP droplet ejection method affects the material contained within the ink.

Whereas inkjet printers eject their droplets from within the nozzle, EHJ printers eject their droplets from outside the nozzle. The ink in an EHJ printer forms a droplet that is attached to the nozzle. This dome of ink is charged by a wire contained within the nozzle using voltages up to 200 V, which is necessary to overcome the surface tension and causes a Taylor cone to form. The droplets are ejected from the tip of the cone. This process likely makes protein susceptible to electrical breakdown and droplet deflection during application of inks to substrates. Furthermore, the EHJP process is still in its infancy and it has not yet been applied to the full range of applications that inkjet printing has. In addition, EHJP is based on electrostatic forces; meaning that the substrate must be conductive, which is also a limitation. Finally, the cost of the technique is another factor to consider.

In some embodiments, extrusion-based printing is utilized to deposit the biopolymer solution on the article. Extrusion-based printing has been widely used in the metal and plastics industries for shape forming different materials and 3D-printing. Extrusion-based printing employs a fluid-dispensing system through an extruder or nozzle to shape form materials and deposit the extruded materials layer-by-layer onto a substrate. Extrusion-based printing systems are computer-controlled to deposit materials layer-by-layer to form 3D structures. Extrusion-based printing systems may operate under a robotic control system.

Computer-controlled extrusion printing allows the realization of 2D and 3D objects with sizes ranging from millimeters up to meters. Computer controlled extrusion is different than inkjet printing in: scale, types of printable inks, and result configurations. Computer controlled extrusion utilize gantries which move the extruder in a direction required to deposit a certain pattern. Gantries may be robotically controlled arms and may include end effectors capable of holding or manipulating tools and substrates. Gantry size can be much larger in extrusion printing, expanding the print bed to meter scales. Inks can be much varied as extrusion technology allows for a wide range of viscosities from liquids, to colloids, to thick pastes. For example, the viscosities of inks used to make objects via computer-controlled extrusion systems are in the range of 500 cPs to 50,000 cPs.

In contrast, ink jet printing allows for liquid drop by drop deposition only. Ink jet printing is limited to very thin applications onto substrates such as paper and fabric. In extrusion printing, inks can be thinly applied onto substrates, form thick layers onto substrates, be extruded in 2D without a substrate, and also form 3D objects similar to layer by layer depositions observed in 3D fused deposition printing.

In some embodiments, spray coating is used to deposit the biopolymer solution onto the article. Spray coating is the application of one or more thin layers of material onto a substrate. Inks in liquid or gas state are sprayed from a reservoir via a nozzle, and left to dry onto the substrate. Systems for spray coating may be computer-controlled systems or use robotically controlled system components. Systems for spray coating may be manually actuated or powered and may contain one or more nozzles. The shape and size of the nozzle may vary and depend on the application. Spray coating techniques also allow for a larger surface area to be printed and depending on the ink composition, functionalized.

In some embodiments, screen printing is used to deposit the biopolymer solution to the article. Screen printing is a technique where a mesh is used to transfer ink onto a substrate, except in areas made impermeable to the ink by a blocking stencil. In one example, textiles are used as a substrate for screen-printing. Textiles are placed on flat substrates. Custom-designed screens loaded with ink compositions are laid on top of them. A squeegee is used to transfer the ink onto the underlying fabric by applying a constant pressure. The screen-printed substrates may be left to dry at room temperature. The viscosities of the ink compositions used with screen-printing techniques may be in the range 3000-5000 cPs. Screen printing allows the functionalization of surfaces that range from tens of millimeters up to tens of meters. The minimum resolution of the transferred features spans between tens of micron up to hundreds of millimeters. In one example, pH sensing fabrics can be implemented via screen printing so that materials are transferred into one dimensional substrates. For instance, objects sensitive to temperature variations can be developed via computer-controlled extrusion printing in order to generate two and three dimensional objects.

In some embodiments, tape layering is used to deposit the biopolymer to the surface of the article. Automated tape laying is a technique where tape is mechanically applied by a tape pressing end-effector onto a mold, creating a multi-layered surface while ensuring that individual layers are oriented in different directions.

### EXAMPLES

The following examples set forth, in detail, ways in which the ink compositions may be synthesized, methods of using ink composition, and methods of fabricating devices from the ink compositions. The following examples will enable one of skill in the art to more readily understand the principles thereof. The following examples are presented by way of illustration and are not meant to be limiting in any way.

### Materials:

Sodium carbonate, lithium bromide, phenol red sodium salt (PR), bromocresol green sodium salt (BG), nitrazine yellow (NY), peroxidase from horseradish Type I (HRP), sodium 3,5-dichloro-2-hydroxybenzenesulfonate (B), 4-aminoantipyrine (A), glycerol, sodium alginate, and 3,3,5,5-Tetramethylbenzidine (TMB) are purchased from Sigma-Aldrich (USA). Acid Yellow 34 (Y) is purchased from Chem Cruz (USA). Lactate oxidase Grade III (LOX) is purchased from Toyobo (USA). All chemicals are used as received and they follow trace metal standard, when possible. Silk cocoons of Bombix Mori silkworm are purchased from Tajima Shoji (Japan). Deionized water with resistivity of 18.2 M2 cm is obtained with a Milli-Q reagent-grade water system and used to prepare aqueous solutions. 100% silk fabric from B&J Fabrics (New York, USA) and 100% cotton t-shirts from UNIQLO (Japan) are employed as substrates for screen-printing.

### Silk Fibroin Solution Preparation:

Briefly, finely chopped Bombix Mori silk cocoons are boiled in a solution of 0.02 M sodium carbonate to remove the sericin layer for 30 minutes. The fibers are washed three times for 20 minutes in deionized water and dried overnight. They are dissolved in a solution of lithium bromide (i.e., 9.3 M) at 60° C. for 4 hours. A 20 wt % solution is obtained and dialyzed against deionized water for 2 days, changing the deionized water 6 times at regular intervals. The final solution is centrifuged twice at a speed of 9000 rpm, at 4° C., for 20 minutes and then filtered to obtain a 7-8 wt % silk fibroin solution.

### Responsive Ink Preparation

Biomaterial-based inks for screen-printing are realized mixing glycerol and sodium alginate (i.e., 4 wt %) in a weight ratio of 1:2.

pH sensing inks are realized using 4 mg/ml of pH indicator and a solution of silk fibroin with a final concentration of 2 wt % are added to the glycerol/sodium alginate mix.

Lactate sensing inks are realized using 340 U/mL of horse radish peroxidase (HRP), 150 U/mL of Lactate Oxidase (LOX), 1:2 molar ratio of A:B (4-aminoantipyrine): (sodium 3,5-dichloro-2-hydroxybenzenesulfonate), 0.45 mg/mL of acid yellow 34 (Y), and either a solution of silk fibroin with a final concentration of 2 wt % (i.e., silk-based inks) or deionized water (i.e., water-based inks as controls) are added to the glycerol/sodium alginate mix.

HRP sensing inks are realized using 10 U/mL of HRP and either a solution of silk fibroin with a final concentration of 2 wt % (i.e., silk-based inks) or deionized water (i.e., water-based inks as controls) are added to the glycerol/sodium alginate mix.

### Rheological Characterization of Biomaterial-Based Inks for Screen-Printing:

The viscosity profile of the inks is measured using an ARES LS2 Rheometer from TA Instruments (USA), and the data are collected and analyzed using TA Orchestra ARES sn 4000-0024. During the measurement, 500 μl of solution is added to a 25 mm cone and plate geometry. Steady Rate Sweep tests are conducted starting at an initial rate of 0.001 s⁻¹ up to 300 s 1, after a Pre-Shear of 0.001 s⁻¹, for 60 s. Ink viscosity profile data are taken at 10 data points per decade, with a duration of 5 s for each shear rate.

### Mechanical Testing of Screen-Printed Substrates:

Original and screen-printed crepe de chine substrates are tested for the assessment of mechanical properties. The tensile strength of fabric samples is measured using an Instron 3366 tester (Instron, Norwood, MA, USA) (55%±5% relative humidity at a room temperature of 24±1° C.) with 1 kN capacity load cell at a speed of 5 mm/min, as specified by the modified ASTM Standard D5035. For each type of sample, five specimens are tested and the stress-stretch plots that represent the average results are reported.

### Scratch Test of Screen-Printed Substrates:

The screen-printed silk surface is placed face-down on sandpaper (standard glasspaper, Grit No. 24, from Sea Abrasifs, France). This surface is longitudinally and transversely moved along a ruler (i.e., 10 cm in each direction) and abraded by the sandpaper under a weight of 100 g; this process is defined as one cycle. Ten and fifteen cycles of mechanical abrasion tests are carried out on the samples. Photos and Scanning electron microscopy (SEM) Images are taken before scratch test and after 10 and 15 cycles of abrasion (i.e., initial damage and broken samples, respectively). SEM images are taken using a SEM ZEISS EVO-10MA (Zeiss, Oberkochen, Germany) at 10 kV accelerating voltage.

### Biomaterial-Based Sensing Inks for Screen-Printing:

Biomaterial-based responsive inks are realized combining a thickener (e.g., sodium alginate), a plasticizer (e.g., glycerol), silk fibroin, and sensing molecules (e.g., pH indicators such as Bromocresol Green (BG), Nitrazine Yellow (NY), and Phenol Red (PR), enzymes, etc) to make colorimetric assays.

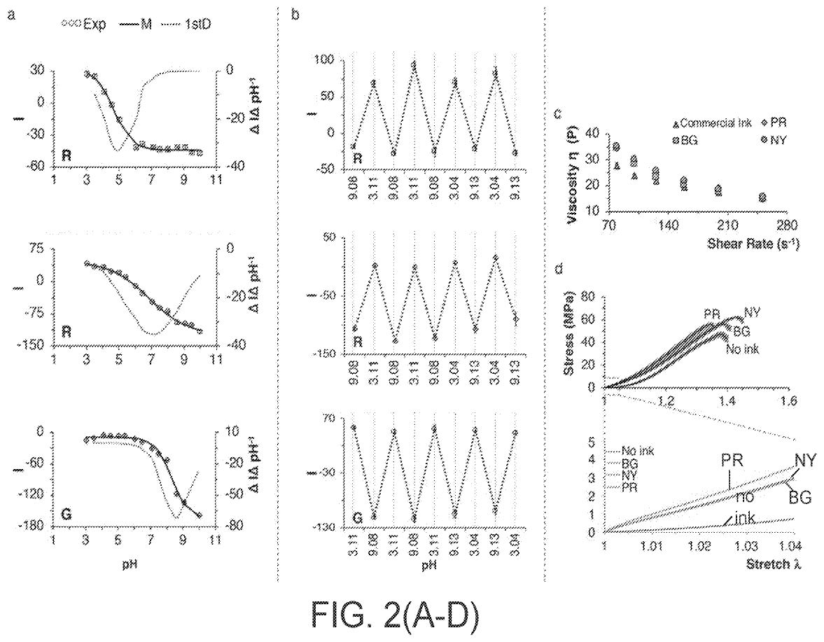

The rheology of the inks is characterized via steady state shear tests to estimate and compare viscosity profiles and “printability” to commercial inks for screen-printing on textiles. A pressure of 0.1 MPa is applied on the squeegee to let the ink flow through the mesh of the screen, so a shear rate range of 100-200 s-1 is used to evaluate the rheological properties of the inks. Biomaterial-based and commercial inks behave as shear thinning fluids and share the same trends. FIG. 2C shows how both biomaterial-based and commercial inks behave as shear thinning fluids following almost matching rheological trends. For both classes of inks, the viscosity, n, decreases from 27.7 P down to 15.1 P for shear rates increasing from 100 s⁻¹ to 200 s⁻¹. The active molecules (i.e., three pH sensitive compounds) added to the biomaterial-based inks do not significantly affect, therefore, rheological properties, which stay comparable to those of their commercial counterparts. The biomaterial-based inks here presented can be successfully screen-printed and potentially used in mass production.

To preserve flexibility and comfort, sensing inks should not alter the mechanical properties of the substrate textiles upon which they are deposited. Protocols from the ASTM Standard D5035 are adapted to estimate the impact of ink printing on the overall tensile strength and elongation at break. Changes to mechanical properties due to ink application can be expected to be more evident for thin and soft substrates. To evaluate a plausible worst-case scenario, we characterize, therefore, the mechanics of ink application on crepe the chine, one of the thinnest existing fabrics.

FIG. 2D shows comparisons between average stress-stretch curves of bare silk fabric substrates and screen-printed silk fabric substrates embedding three different pH indicators. The plots reveal differences especially at small deformations (2=1.00-1.04), where the bare substrates are more compliant with an average stress-stretch slope of 18.5±0.1 MPa (n=5). Under similar conditions (2=1.00-1.04), screen-printed substrates are stiffer, and exhibit average stress-stretch slopes of 73.1±0.4 MPa (n=5) for Bromocresol green (GB), 75.1±0.4 MPa (n=5) for Nitrazine Yellow (NY), and 90.3±0.6 MPa (n=5) for Phenol Red (PR), respectively. At larger extensions (i.e., from 2=1.15 up to the beginning of failure), all substrates behave similarly as they exhibit a stiffer quasi-linear behavior. Average stress-stretch slopes at 2=1.15 are 178±2 MPa for bare silk and range between 183±3 MPa and 201±3 MPa for screen-printed substrates. The bare substrates start to break at 2=1.38, which correspond to an average failure strength of 47.4±4.5 MPa (n=5).

Printed substrates start to break at similar stretch levels but reach higher failure strengths (i.e., BG: rupture at 2=0.38, failure strength=56.1±1.9 MPa (n=5); NY: rupture at 2=0.43, failure strength=62.4±1 MPa (n=5); PR: rupture at 2=0.37, failure strength=54±7.3 MPa (n=5)). Differences in mechanical behavior are more evident at small extensions, likely due to screen-printing decreasing the degrees of freedom of the fabric. At larger deformations, stress-stretch behavior of bare silk and printed substrates is similar, although printed substrates withhold larger stresses before breaking. Overall, functionalization via screen-printing does not alter mechanical behavior enough to affect the draping and comfort properties of the substrates.

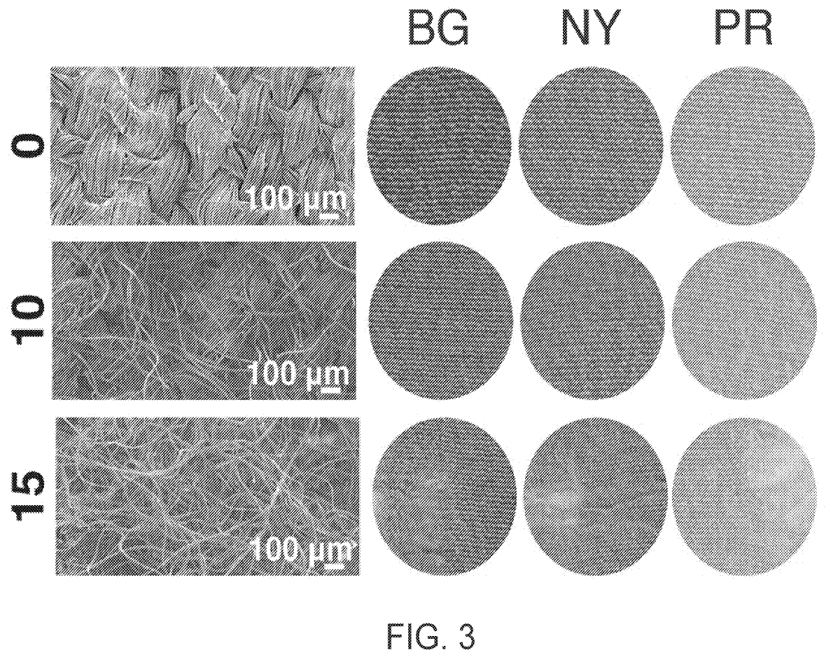

The robustness and adhesion of the inks to the fabric is also evaluated after sandpaper-abrasion tests. FIG. 3 shows how the surface of the samples is damaged after 10 cycles and breaks after 15 cycles, a behavior that is observed for all the substrates independently from the ink used. The ink does not peel off, as both the fracture and the threads taken from the first layers of the fabric weaving pattern demonstrate that the ink is completely absorbed through the textile.

### Analysis of Colorimetric pH Sensing Textiles:

The results of textile-based pH colorimetric sensors can be interpreted by eye, by an electronic reader (e.g., flatbed scanner), or by a camera. Color changing layers are scanned with an 8-bit Laser Jet Pro MFP M127fn scanner from HP (USA), using 24-bit color depth and a resolution of 600 dpi. Photos are taken with a Canon EOS Rebel Tli in controlled lighting conditions. ImageJ allows quantifying the signal as variations in the Red (for BG and NY) or Green channel (for PR), which were the most sensitive to the color changes in the pH indicators. The experimental data are fitted with a regression analysis that resulted in a calibration model for the best-fit sigmoid curve (i.e., Boltzmann technique) whose first derivative provides an estimate for eventual shifts in the pKa of the pH indicator embedded in the biomaterials. [7,8] Multispectral images are collected with a CRI Nuance EX. Images and spectra are acquired in the range 450-750 nm, at a step of 5 nm, and all the information is processed and analyzed using the Software Nuance 3.0.2.

### Analysis of Colorimetric Lactate Assays on Textiles

The results of lactate colorimetric sensors realized on textiles can be interpreted by eye or by an electronic reader (e.g., flatbed scanner). Color changing layers are scanned with an 8-bit Laser Jet Pro MFP M127fn scanner from HP (USA), using 24-bit color depth and a resolution of 600 dpi. ImageJ allows quantifying the signal as variations in the Red, Green, and Blue channels combined together into the Euclidean Distance, which combination correlates the color changes to the variations in the lactate concentrations.

### Screen-Printing on Cotton Substrates:

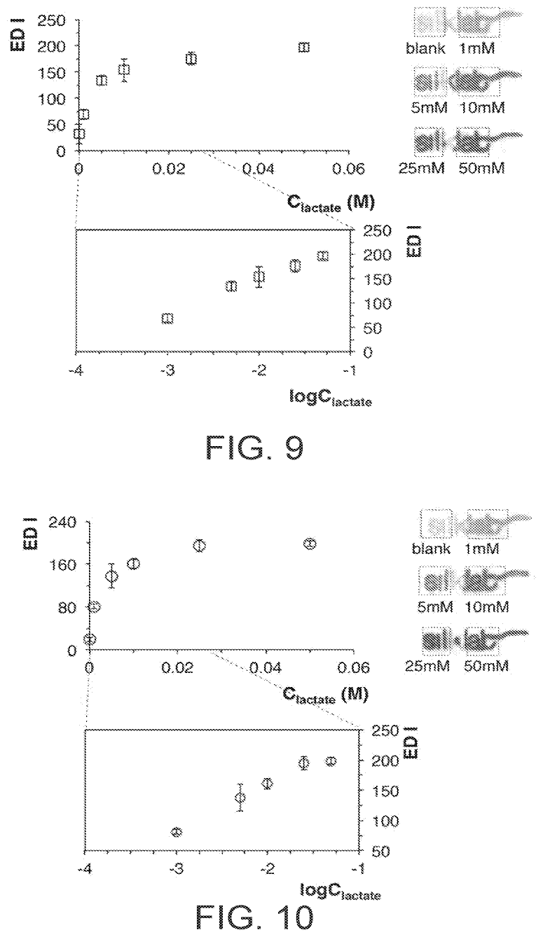

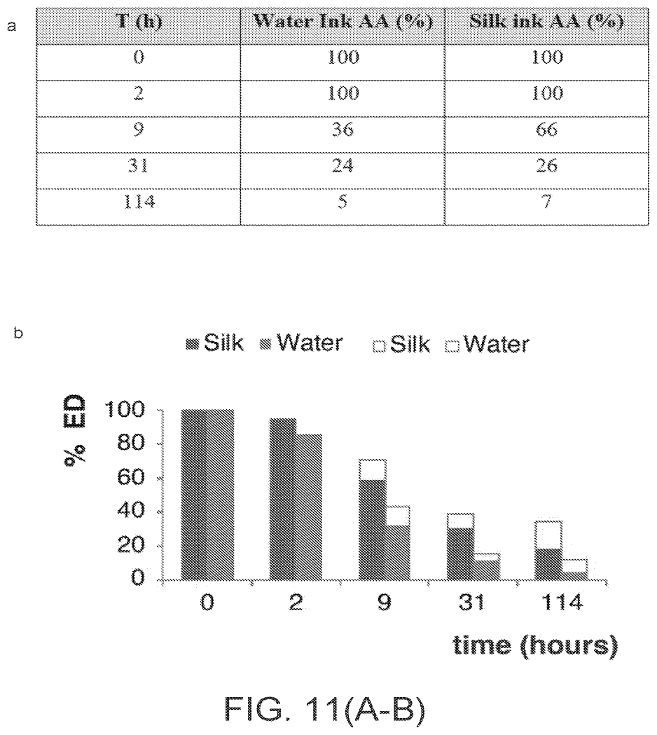

Water- and silk-based colorimetric assays are screen-printed on cotton substrates (FIG. 9 and FIG. 10). The substrates are first calibrated on the bench using solutions that mimic sweat composition as shown by the intensity variation of the Euclidean distance within the physiological range 1-50 mM of lactate in sweat (i.e., water-based inks: Sensitivity, 74.3±12, (n=3); silk-based inks: Sensitivity, 72.6±2 (n=3)). The sensing substrates are stored at 75° C. (i.e., above thermal stability) to perform an accelerated aging test and assess the ability of silk-based inks to maintain enzymatic activities when exposed to lactate variations (i.e., 50 mM) after 2, 9, 31 hours and 114 hours (FIG. 11).

After 2 hours, water and silk-based assays lose 15% and 5% of enzymatic activity, respectively. After 9 hours, the activity decreases to 32% and 60% in water and silk-based assays, respectively (FIG. 11); both water and silk-based patterns are featured by inconsistent colorimetric changes to lactate variations with the active area reduced to 36% and 60%, respectively. After 31 hours, the water-based screen-printed regions stop working (i.e., overall activity decreases to 12%) but the silk-based ones perform better with an overall activity diminished to 32%. The substrates were kept in the oven in the same conditions for additional 4 days (i.e., 114 hours in total). FIG. 11 shows that 5% of the water-based pattern is featured by 12% of enzymatic activity but the one calculated over the entire sensing area is 4%: lactate detection is not feasible anymore. However, 7% of the silk-based pattern shows activities of 35% but the overall colorimetric behavior is almost lost (i.e., 18% of enzymatic activity over the whole sensing area).

### Analysis of HRP Activity on Textiles:

HRP activity can be interpreted by eye or by an electronic reader (e.g., flatbed scanner). The screen-printed substrates are exposed to TMB (i.e., causing a shift from transparent to blue) and a stop solution of 0.1 M sulfuric acid (i.e., causing a shift from blue to yellow). Color changing layers are scanned with an 8-bit Laser Jet Pro MFP M127fn scanner from HP (USA), using 24-bit color depth and a resolution of 600 dpi.

### Screen-Printing on Cotton Substrates:

Water- and silk-based colorimetric assays are screen-printed on cotton substrates to detect HRP activities through colorimetric reactions with TMB after drying at room temperature. The substrates are kept at 60° C. for 5 days and the activity is monitored after 9 hours and 5 days showing the ability of silk-based inks to preserve better the activity of the enzymatic assay. The HRP activity decreases down to 66% but it is nearly lost by the water-based patterns after 9 hours and almost lost for both assays after 5 days (i.e., as shown by the absence of visible color changes.

### Realization of Colorimetric Interfaces:

Clear acetate masks allow transferring custom designs on screens coated with a photo emulsion layer (i.e., from Ulano, USA) using UV-light exposure. These screens are laid on top of textiles placed on flat substrates. A squeegee tilted at 45° is used to transfer the ink through the screen onto the underlying fabric by applying a constant pressure. The screen-printed substrates are left to dry at room temperature overnight. All the substrates are stored in the dark at room temperature.

### pH Sensing Substrates:

The screen-printed substrates are water annealed in a humidity chamber at 45° C. for 24 hours. The fabric was then steamed and left to dry before undergoing dry cleaning.

### Lactate Sensing:

Color intensity variations are measured in terms of Euclidean distance within the physiological range 1-50 mM of lactate in sweat (i.e., water-based inks: Sensitivity, 98.2±19, (n=3); silk-based inks: Sensitivity, 77.9±13 (n=3)). The relative standard deviations between readings are on average 9% and 5% for water and silk-based inks, respectively. These values demonstrate good reproducibility in production of the sensing platforms, which also show no appreciable differences in sensing performances.

### Screen-Printed Substrates for pH Sensing

The integration of active inks via screen-printing allows mass-production of responsive, soft, wearable interfaces that can conform to the surface to be monitored. Exploiting the opportunity to encapsulate colorimetric sensing agents within biomaterial-based inks, sensing surfaces are realized and they can monitor pH variations in real-time. Color changes are detected by photographing (and post-processing using ImageJ) to correlate the intensity variation of the most sensitive red, green, or blue (RGB) channel towards the change of pH in the monitored solution.

Depending on the ink and on the pH of the monitored solution, the color channels exhibit varying levels of sensitivity. FIGS. 2(A-B) shows intensity variation of the Red channel (for BG and NY) and the Green channel (for PR) in each sensing textile, within the pH range 3-10. BG substrates are sensitive within the range pH 3.5-6 (Sensitivity of Red Channel: −26.5±0.8, (n=3)), NY substrates are sensitive within the range pH 5-8.5 (Sensitivity of Red Channel: −32.4±0.8, (n=3)), and PR substrates have a double linear trend within the ranges pH 6.5-8 (Sensitivity of Green Channel: −22.4±1, (n=3)) and pH 8.5-10 (Sensitivity of Green Channel: −29.5±2, (n=3)).

The experimental data were fitted with regression analysis that resulted in a calibration model for each dye based on the following equation (Boltzmann technique):

$$RGB Intensity = [ \frac{a}{1 + {exp}^{b ( pH - z )}} e ] + d$$

a is the peak height, b is the slope coefficient, z is the point of inflection (i.e., pKa), e is the symmetry parameter for the sigmoid, and d accounts for a baseline offset. The first derivate of the model allows the estimation of the pKa of each ink: BG pKa=4.7, NY pKa=6.85, and PR pKa=8.3. Each value is slightly shifted: ˜−0.2 units for BG, ˜+0.25 units for NY, ˜+0.3 units for PR. This phenomenon was previously recorded and accounts for the immobilization of the dye into a microenvironment that differs from the standard deionized water in which these dyes are usually dissolved.

The sensing textiles embedding BG and NY are able to discriminate 0.1 and 0.2 units of pH, respectively, while those embedding PR are able to discriminate 0.2 and 0.5 units for the first and second linear range. Obtaining resolutions of 0.1 units with a functionalized sensing textile is an achievement first of its kind that opens up novel pathways towards the detection and discrimination of at least 0.5 units of pH by tuning the biomaterial-based inks here introduced. Moreover, the small relative standard deviations in between readings recorded at the same pH on different substrates realized using the same technique, are on average 8% for BG, 5% for NY, and 11% for PR, respectively (FIG. 2A). These values account for the reproducibility of the process here employed to convert inert into interactive substrates.

FIG. 2B shows reversibility of the functionalized substrates. The pH within the same regions of BG and PR is repeatedly changed between basic (i.e., pH=9) and acidic (i.e., pH=3) (i.e., 1 cycle) levels 9 times. The final readings recorded at pH 9 are shifted from the initial basic assay with a relative standard deviation between the first and final reading of ˜26% and ˜12% for BG and PR substrates, respectively. The pH within the same region of NY is repeatedly changed between acid (i.e., pH=3) and basic (i.e., pH=9) levels 9 times. The final readings recorded at pH 3 are shifted from the initial acid assay with a relative standard deviation between the first and final reading of ˜14% (n=9). These variations can be attributed to minor leaching occurring during the test. The compositions may be modified with the addition of commercial binders, but even without corrections the sensing abilities are preserved.

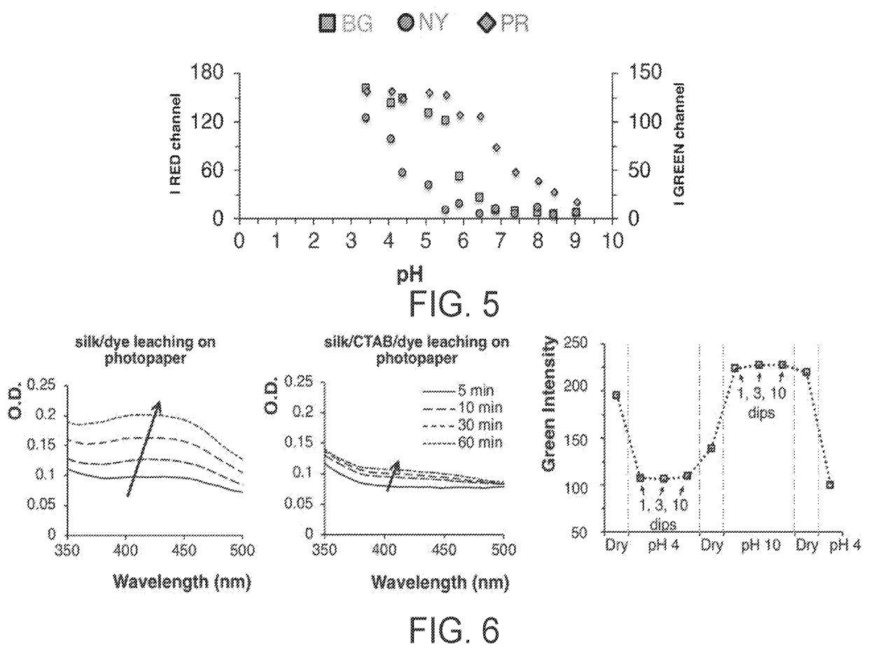

Moreover, the damaged surfaces (FIG. 3) maintain their sensitivity (FIG. 5) after sand paper abrasion, with relative standard deviations between the undamaged and damaged surfaces of ˜8%, ˜1%, and ˜4% for BG, NY, and PR, respectively. As a qualitative test, the fabrics were sent to a local dry-cleaner and cleaned as silk garments would ordinarily be. Upon return of the fabrics from dry cleaning, tests were performed and the different sensing molecules maintained their sensitivity and reversibility further offering promise for the practical adoption of these materials.

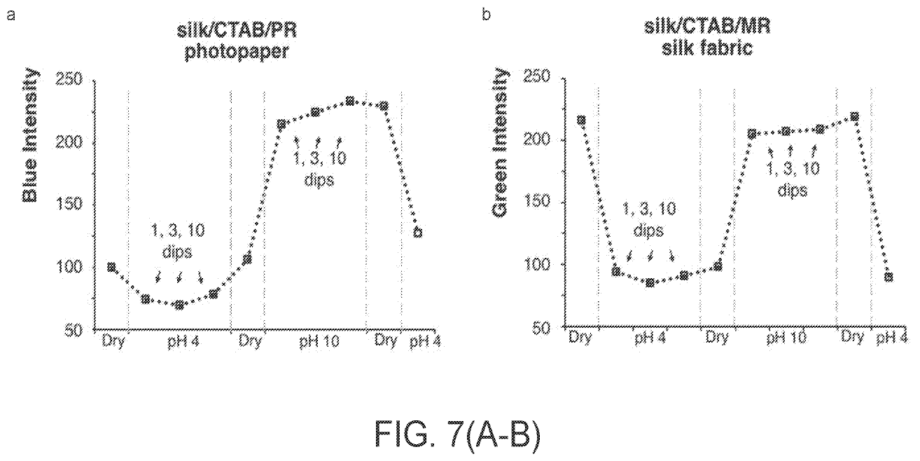

FIG. 7A-B shows that the surface of the samples is damaged after 10 cycles and breaks after 15 cycles, a behavior that characterizes all the substrates despite the ink used. The ink does not peel off, the fracture and the threads removed from the first layers of the fabric weaving pattern demonstrate that the ink is completely absorbed in all layers of the textile. The damaged area is still sensitive, with relative standard deviations between the undamaged and damaged surfaces of ˜8%, ˜1%, and ˜4% for BG, NY, and PR, respectively.

There are only a few examples of textiles embedding colorimetric pH sensors. They work in a reduced pH range, their active areas are small in scale and they are either stitched on other textiles or embedded within microfluidic platforms that make the devices bulky. The functionalized areas are on the order of square meters, with resolutions down to hundreds of μm, and with multispectral combination of colors allowing distributed mapping of different environments they get in contact with. These results are first of their kind and they are appealing for environmental and biological real-time monitoring of pH variations.

### Screen-Printing Discussion:

Biomaterial-based responsive inks are formulated for screen-printing applications by combining a thickener (sodium alginate), a plasticizer (glycerol), and regenerated silk fibroin. This formulation is made responsive through the addition of molecules such as pH indicators or enzymes (among others). The rheological properties of the inks are optimized to match the traditional shear-thinning behavior found in commercial inks used for screen-printing applications. Characterization of the biomaterial-based inks' viscosity profile and mechanical properties post-printing was performed with different pH-responsive ink formulations printed on textiles. The addition of responsive molecules does not affect rheological behavior and allows for large printed geometries to be realized onto textile substrates.

Examples of the versatility of the approach are shown in FIGS. 1A-B, which illustrate different exemplary formats of chemically responsive textiles obtained from screen-printing the composite bioink formulation described above. Screen-printing may be performed on various kinds of substrates (e.g., textiles, paper, etc) with a resolution ranging from 1.25 mm to 100 μm. Patterns may be designed on patches, scarves, tapestries, etc.

As a demonstration, biomaterial-based inks are encapsulating colorimetric pH-responsive molecules, namely nitrazine yellow (NY), bromochresol green (BG) and phenol red (PR). pH variations can be monitored in real-time by measuring variations of intensity for the red, green, or blue (RGB) channels. For these particular formats, the BG and NY sensing textiles are able to discriminate down to 0.1 and 0.2 units of pH, respectively, while the PR ones are able to discriminate down to 0.2 and 0.5 units within the first and second linear range, respectively and are reversible for multiple uses across their response pH ranges.

Additionally, tests on mechanical durability and function are performed with sand paper abrasion tests showing that the reactive fabrics maintain their sensitivity (FIG. 3 and FIG. 5) after abrasion. Lastly, the sensitivity, with response in the same pH range, and reversibility was still maintained after dry cleaning the printed fabrics.

These feasibility studies open the path towards the realization of sensing garments. Few examples of fabrics able to detect pH variations through color changes exist, with wearable colorimetric sensors typically stitched onto other textiles or embedded into microfluidic platforms as part of more complex devices with embedded sensing and detection/transmission units. Commonly, such sensors work over a reduced pH range, with low sensitivity and with sensing areas restricted to small surfaces.

The distribution of colorimetric sensors on a large scale and on “traditional wearable interfaces” (i.e., garments of common availability) has been so far overlooked and could offer an interesting complementary approach.

To demonstrate the concept, cotton T-shirts are screen-printed in discrete patterns with multiple sensing inks to topographically detect pH variations in real-time. Circles are first printed on the front and back of T-shirts for whole upper-body pH mapping (FIG. 1). Five separate inks are used of which, three are pH sensitive (i.e., BG, pH range 3-5; NY, pH range 4-7; PR, pH range 6-8), while the remaining two act as non-reactive controls and fiducial markers to correct for lighting artifacts at the image processing stage.

Different regions of the t-shirt change color after spraying with sweat-like solutions at different pH (i.e., a first region sprayed with pH 4 and a second region sprayed with pH 8 demonstrated different color changes). A multispectral camera was used to provide a map that describes spatial variations of the analyte (i.e., within each singular circular spot). The visible color changes are quantified into spectral readings covering a wavelength range of 450-750 nm for the 3 pH indicators. The fiducial markers maintained their color, also shown by the overlapping spectra recorded at different pH for multispectral calibration on a T-shirt within the range pH 3-9). Average calibration spectra of color changing (i.e., BG, NY, and PR) and reference (i.e., red and blue) circles were analyzed using Nuance software

A demonstration is carried out by spraying sweat-like solutions with different pH (i.e., range pH 5-7) across the T-shirt mimicking the distribution of sweat physiologically recorded on the upper torso. The response is recorded as a RGB signal to account for practical use cases employing common CCD cameras.

The pH of two different areas were measured before and after spraying (i.e., A′ pH 6.2; B′ pH 7). It is observed that it is possible to notice color changes within the pH sensing circles while no changes occur for the reference dots. The whole T-shirt is able to detect point by point variations and conveys information in a “map-like” format when tested in controlled laboratory conditions.

Real-time monitoring of pH variations using colorimetric distributed sensors on a T-shirt via multispectral camera recordings were performed. The average spectra represent three color changing circles containing NY, PR, and BG as pH indicators, and two reference circles containing a stable pigment. The spectra are obtained using Nuance software. Unmixed signal images for the three pH sensing circles (i.e., NY green channel, PR magenta channel, and BG blue channel) and for the two reference circles (i.e., blue associated to the cyan channel and red associated to the red channel) are processed using Nuance software.

T-shirts with the same design were also tested by wearing them during physical exercise. The areas in contact with the wearer's sweat change color leaving a specific signature on the encoded responsive pattern. Distributed sensing allows to identify and map the areas of the back that have produced more sweat during exercise and a measure of their pH. Image post-processing allows to extrapolate pH variations point by point by analyzing within individual color changing circles. pH values can be extrapolated from the median gray intensities of the three indicators revealing a response within the acidic range (i.e., from 4.9 up to 5.7) and its corresponding distribution.

By mapping sweat-induced pH distribution more information could be added for dehydration monitoring and to strategies to correlate a physiological parameter of a subject, e.g., sodium concentration with sweat rates. These approaches can be extended to multiple types of textiles and garments (such as sheets, pants, shoes) and paired with real-time video analysis for distributed sensing based on multiplexed screen-printed chemistries.

The formulation of inks presented here, is particularly suited to expand the range of printable sensors to ultimately generate bioreactive fabrics. As an example to demonstrate these attributes, enzymatic inks were formulated and tested. Lactase oxidase was selected as a test molecule given its relevance for exercise and human performance monitoring. Lactate levels are indicative of exercise intolerance, displaying a shift from aerobic to anaerobic conditions during training sessions.

Lactate variations are usually monitored using enzymatic assays with one of their main drawbacks being the progressive decrease in stability of dried proteins during storage at room temperature. FIGS. 9-10 show results from tests comparing performance of lactase oxidase mixed to either water or to silk fibroin-based inks upon screen-printing on silk substrates. The substrates are first calibrated using solutions that mimic sweat composition. The sensing substrates are subjected to accelerated aging tests by storing them at 75° C. (i.e., above thermal stability of the enzymes) to assess the ability of silk-based inks to maintain enzymatic activities when exposed to lactate variations (i.e., 50 mM) after 2, 9, 31 hours and 114 hours (FIG. 11A-B).

After 2 hours, water and silk-based assays lose 7% and 1% of enzymatic activity, respectively. After 9 hours, the activity decreases to 45% and 95% in water and silk-based assays, respectively. The water-based pattern is characterized by inconsistent colorimetric changes to lactate variations: 51% of the overall sensing area is still active. The silk fibroin pattern maintains instead unaltered performance and is featured by even colorimetric changes (i.e., only 5% of activity lost since the beginning) (FIG. 11A). After 31 hours, the water-based patterns are degraded (i.e., overall activity decreases to 24%) presenting 25% of the overall area still active. The silk-based patterns show more uniform color changes throughout the printed area (i.e., overall activity decreases to 55%) with localized activities of 80% over 62% of the whole sensing regions.

After 114 hours, the water-based screen-printed regions stop working. The silk-based ones still perform around the borders (i.e., localized activity of 35% throughout 41% of the whole sensing pattern) although the overall colorimetric behavior decreased significantly. These results highlight that the enzymatic activity of lactate oxidase embedded within silk-based inks is preserved overtime and still allows effective colorimetric detection when sensing substrates are stored in conditions up to 31 hours.

An additional test was performed by embedding horseradish peroxidase (HRP) in the ink to verify stability of the enzyme in its printed textile format. These substrates were stored at 60° C. for 5 days and monitored over time revealing the ability of silk-based inks to preserve the overall enzymatic activity (i.e., decreased down to 67%) compared to the water-based controls in which activity is nearly absent after 5 days. The same approach is used to functionalize cotton substrates with both lactate and HRP. These results extend the utility of the use of silk as a biological stabilizer and open the way towards the implementation of complex patterns of chemical and enzymatic assays for multi-analyte detection in shelf-stable, refrigeration-less formats.

The integration of bioactive inks via screen-printing opens a promising direction towards mass-production of responsive, soft, wearable interfaces for distributed sensing. The ability to programmatically localize and stabilize patterns of reagents over large areas opens avenues for individual and environmental sensing adding complementary solutions to the challenges encountered, for example, when relating local sensor measurements (e.g., pH, Na⁺, K⁺, etc. in sweat) to variations able to account for systemic changes (e.g., in hydration levels). Bioactive biomaterial-based ink formulations can be printed on a variety of surfaces, including paper, polymer substrates, or textiles in highly reproducible fashion covering areas from millimeters to several meters with resolution in the hundreds of micrometers, enabling distributed chemical mapping of the interface.

Demonstrator shirts coupled with commonly used CCD cameras were used as a case study for the feasibility of the approach, paving the way towards real-time detection of multiple analytes via conformal, passive interfaces that can be used to acquire information to evaluate the state of the wearer and/or the surrounding environment. Pairing this approach with improved pattern design, image analysis and post-processing, and learning algorithms can provide rapid (ideally real-time) responses and lead to compelling wearable diagnostics where colorimetric maps can define physiological libraries to improve athletic performance and/or better monitor the health status of an individual while providing the ability to compensate for additional environmental challenges such as variations in illumination and subject geometry during use. Extending these distributed strategies beyond the human body by selecting particular combinations of sensing inks could also provide new approaches in environmental monitoring and sensing for multiple applications, ranging from air quality, epidemiology, or disease tracking to name a few.

### Biomaterial-Based Sensing Inks for Inkjet Printing

The working window of printable solutions for inkjet printing is smaller than the one that describes screen-printing. The “printability” of these inks is described by a dimensionless number

$$Z = {( γρ a )}^{1 / 2} / η$$

where γ, ρ, a, and η are the surface tension, density, nozzle orifice and viscosity, respectively. Silk fibroin needs to be extracted from 120 minutes boiling (120 mb), and the concentration of the solution has to be adjusted to 4 wt % with deionized water to attain fluids with lower viscosity and thus less prone to clog the nozzles. pH indicators in powder format (i.e., BG, NY, and PR) are added to the silk solution prepared as stated above. The viscosity of the inks is characterized via steady state shear tests. FIG. 2C shows that 120 mb silk inks behave as Newtonian like fluids, with a viscosity of about 2.55±0.26 cP in the shear rate range of 30-100 s−1. It can also be noticed that the addition of pH indicators does not affect the viscosity of the colorimetric inks (i.e., BG 2.50±0.19 cP, NY 2.20±0.36 cP, and PR 2.69±0.33 cP) when compared to blank 120 mb 4 wt % silk solution, which indicates that no obvious physical change is observed within the mix.

The surface tension of 120 mb 4 wt % silk solution is 54.46±0.21 dynes cm⁻¹. The BG, NY, and PR, however, exhibit lower surface tensions 47.57±0.32, 48.44±0.01, 49.25±0.17 dynes cm⁻¹, respectively. The decreased surface tension can be ascribed to the accelerated gelation of the protein-based solutions. FTIR spectra in show that the hydrogen bonding between fibroin molecules generating beta-sheet secondary structures (i.e. an increase in the peak at 1514 cm⁻¹ (silk II)) is accelerated by the addition of salt-like molecules like the pH indicators. However, due to the combined low molecular weight chains of silk fibroin degummed over 120 minutes, gelation takes place in a rather long time scale (e.g. months) and the acceleration caused by the addition of pH indicators in fresh prepared solution does not affect the printing process.

According to the viscosity and surface tension measured, using a cartridge with a nozzle diameter of 21 μm, the colorimetric biomaterial-based inks for inkjet printing have a Z˜13, which is close to the optimal range for the Z value (i.e., 1<Z<10) determined for a stable drop formation. This confirms the inkjet-based printability of the biomaterial-based inks here described.

### Inkjet Printed Substrates for pH Sensing

Deposition of functional reactive materials through inkjet printing allows direct active printing at the microscale on diverse substrates, with precise resolution control and minimal material consumption (i.e., 1-10 picolitres).

The functionalization of selected areas of everyday low-cost materials such as paper, allows the realization of miniaturized patch-like devices that can be attached to multiple human body locations to real-time monitor pH variations in sweat during, for instance, running sessions. pH is a good indicator for dehydration as it can be correlated to sodium concentration and to sweat rates and its monitoring can help implement optimal hydration strategies.

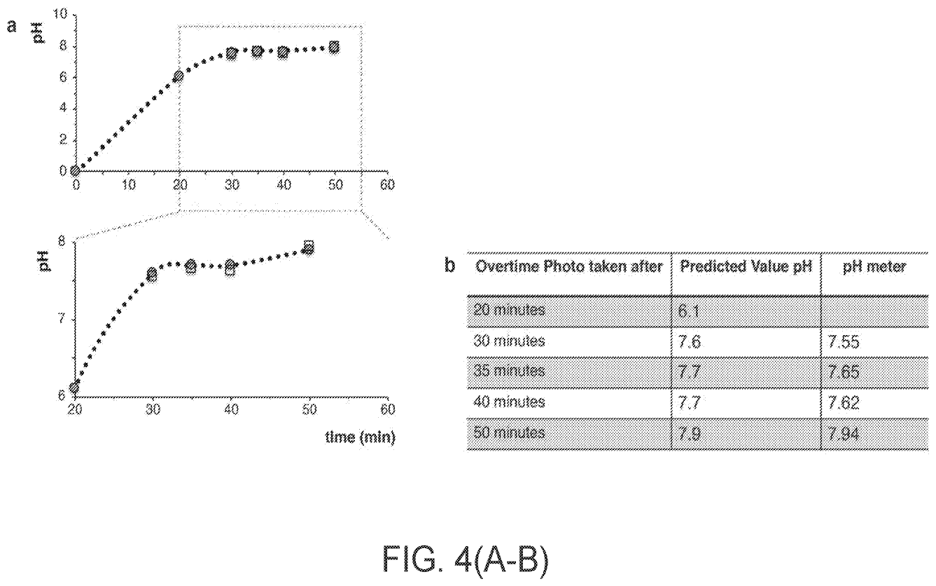

FIGS. 4A and 4B show pH data from a sensing patch (e.g., FIG. 1B) that has been positioned on the arm of a volunteer. It is composed of six inkjet printed circular sensing elements 22. Three areas are used for pH detection (i.e., number 4, 5, and 6) and three for reference (i.e., number 1, 2, and 3). Each sensing circle has a diameter of 2.5 mm and embeds a different pH indicator within a silk fibroin ink (i.e., 4 NY, 5 PR, 6 BG), to detect variations within the physiological range of pH in sweat (i.e., pH 4-8) in a colorimetric fashion. The device is first calibrated on the bench using solutions that mimic sweat composition with pH changes within the range 3.5-9. Photos of colorimetric results are taken with a commercial smartphone camera and the pH value associated to each patch is obtained after image processing.

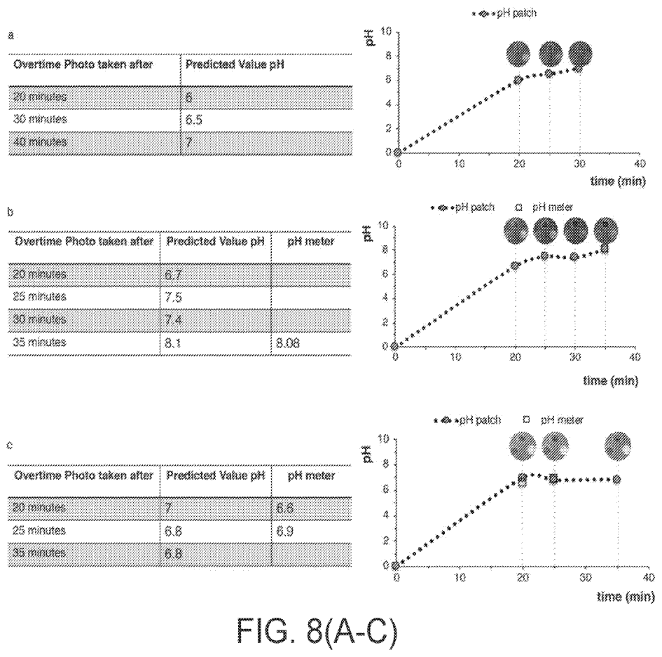

First, light calibration takes place using the circular reference areas to compensate for variations in color due to potential changes in ambient lighting. Second, the calibration images, in conjunction with the known pH values of the calibration solutions (i.e. measured with a pH meter), provide a set of data from which a pH predictor is developed (see FIG. 8(A-C)). The pH predictor is based on changes on red, green, and blue color channels, and in hue intensity of the 3 detection areas. Maximum prediction error is ≤0.1, indicating that this approach can potentially provide estimates able to monitor variations of pH with resolutions of +0.15.

The patches are then tested on volunteers to show their real-time applicability. They are positioned on the lower back (Trial 1) or on the neck (Trial 2, 3, and 4). Volunteers run at a self-adapted intensity inducing sweating and they stop when they reach point of near exhaustion. FIG. 4B shows how a neck patch changes color during a running session. The photos are taken at specific time intervals, namely, at the beginning and after 20, 30, and 35 minutes. The color of the patch starts shifting after 20 minutes (FIG. 4B) when sweat gets in contact with the detection areas and evolves over time (i.e., after 30 and 35 minutes). A commercial skin pH meter was also positioned around the patch for parallel manual reference measurements of sweat to be compared to the ones extrapolated by image processing.

All the other trials show the evolution of estimated and recorded pH during running sessions. In general, estimated pH values through camera photo-based colorimetric analysis agree with the ones recorded by a pH meter (i.e., on average within the range of +0.1). The recorded differences can be related to the fact that the area monitored by the patch and the pH meter cannot overlap as the pH meter is positioned around the patch. pH values increase over time, accounting for higher sweat rates. Better insights on the physiology of sweat can be obtained distributing and simultaneously monitoring multiple body locations. These tests are now undergoing within the lab and they will allow moving from local to pervasive monitoring of pH variations using multi-spectral patch-like devices.

The leaching of pH sensing indicators may be observed on inkjet printed surfaces with sole silk/dye mixes as a result of poor attachment to the substrate. However, the entrapment of pH indicators can be improved using a two-step reactive inkjet (RIJ) printing process to functionalize photo paper and silk textiles. FIG. 6 shows two types of inkjet printed pH sensors based on methyl red (MR): a silk/dye mix transferred by direct inkjet printing on photo paper (FIG. 6 left), and a silk/CTAB/dye gel mix generated via RIJ on photo paper (i.e. CTAB/dye mixture was printed on top of 5 layers of silk solution deposited in advance, FIG. 6 middle). The substrates undergo multiple washing cycles in deionized water at pH 4 and pH 10 to quantify leaching of the indicator and sensing performances over time.

Significant color fading is noticed for silk/dye mixes on photo paper. FIG. 6 left shows the variation in the absorbance spectra of the deionized water based washing solution sampled after 5, 10, 30, and 60 minutes of vigorous vortexing. The broad peak recorded in the range 400-450 μm indicates the presence of MR after 10 minutes. The intensity of this peak increases significantly over time and it accounts for the leaching of MR from the photo paper, and the fine texture that does not withhold the silk/(MR) mix. The problem can be tackled using cetyltrimethylammonium bromide (CTAB), a cationic surfactant which charge and hydrophobic alkyl groups lead the formation of random coil secondary structures in fibroin solution allowing the development of a silk hydrogel (referred as silk/CTAB/dye composite). FIG. 6 middle shows that absorbance is stable overtime within the range 400-450 μm (i.e., accounting for MR leaching after 60 minutes of vigorous vortexing), suggesting enhanced MR entrapment through RIJ. The silk/CTAB hydrogel can act as a cage that physically traps MR, hampering its leaching through charge effects. This silk/CTAB/dye composite formed by RIJ, not only prevents the pH indicator from leaching, but also enables reproducible pH sensing. FIG. 6 right shows the variations on the Green channel depending on pH changes during repetitive washing cycles of photo paper withholding a layer of “silk/CTAB/dye”. Intensities are stable within +1.42 units for pH 4 and +2.15 units for pH 10 after 1, 3, and 10 washing cycles. After drying, the sensing substrates exhibit similar Green intensities (i.e. standard deviation of +4.86) when back in contact with pH 4, which demonstrates sensing robustness and reversibility. This approach is also versatile: it is compatible with different substrates (e.g., silk fabrics) and “silk/CTAB/dye” can embed other pH indicators (e.g., PR, litmus, etc).

### Perspectives on Distributed Sensing for Different Applications

Distributed sensing found application at the intracellular level (i.e., to sense pH variations via silicon nano-needle arrays) but there is the opportunity to explore this approach on different scales and using low-cost substrates. As discussed before, screen-printing has the advantages of transferring a versatile range of biomaterials on different substrates on large scales. Herein, a cotton t-shirt (e.g., FIG. 1A) is screen-printed with a pH sensing ink embedding NY which is sensitive within the pH range 5-7, to realize point-by-point real-time human body sweat monitoring in a distributed fashion. A cross pattern was first distributed on the front and back of the t-shirt, covering the upper torso and armpits, areas featured with high sweat rates. The t-shirt was tested on the bench by spraying various areas (e.g., separated into A, B, and C) with sweat-like solutions at different pH. The t-shirt works as a map that can monitor the way pH varies point by point. pH was extrapolated from the calibration model obtained after image processing. Each area is featured by an average value of: A, pH 6.8±0.3; B, pH 6.5±0.1; C, 5.9±0.2.

Using a similar strategy, five different inks were screen-printed to fully cover a cotton T-shirt for a whole upper-body sweat pH mapping with enhanced data reliability and aesthetics. Three inks were pH sensitive within different ranges (i.e., BG, pH 3-6; NY, pH 5-7; PR, pH 5.5-8.5) and the other non-reactive two can be used for light calibration during image processing. This screen-printing distributed configuration also allows multispectral analysis that can be adapted and transferred onto different substrates depending on the final application, which, in turn, can also be adapted to monitor multiple analytes conveying physiological relevant information to improve athletic performance and human health. This configuration opens avenues towards distributed sensing on more large scale surfaces of different kinds such as wall paper, interior partitions, tensile canopies, or the tapestry-like format.

This wall hanging textile (i.e. on the scale of 3×1 m) can sense the environment it interacts with (e.g. variations of pH in rain, water, etc.) allowing the implementation in the built environment of macro-scale formats that, in the near future, might be able to track weather and pollution by simply altering the sensing molecule within the ink formulation.

The present disclosure has described one or more preferred embodiments, and it should be appreciated that many equivalents, alternatives, variations, and modifications, aside from those expressly stated, are possible and within the scope of the invention.

1.-36. (canceled)

37. A coated article, comprising:
a substrate forming a three-dimensional hierarchical body, the body having opposing ends on respective opposing surfaces of the body defining a first surface and a second surface;
an array of sensing elements in contact with the first surface of the substrate forming a pattern across the first surface, the sensing elements being transformable from a first chemical-physical state to a second chemical-physical state in response to a change in one or more environmental parameter, the array of sensing elements composed of:
(i) silk fibroin, and
(ii) a sensing additive.

38.-61. (canceled)

62. A method of colorimetric sensing,
contacting an array of sensing elements printed on a substrate with an environment, each of the sensing elements comprising an ink composition, the ink composition comprising silk fibroin and an environmentally-responsive dye dispersed therein, wherein the array of sensing elements undergoes a color change in response to an environmental parameter; and
detecting the environmental parameter from pixel intensities or colorimetric values of the array in an image of the array.

63. The method of claim 62, wherein the ink composition further comprises a surfactant.

64. The method of claim 63, wherein the surfactant is present in the ink composition in an amount sufficient to induce formation of a silk fibroin matrix that hinders leaching of the environmentally-responsive dye entrained therein.

65. The method of claim 64, wherein the silk fibroin matrix is characterized as having a random coil secondary structure.

66. The method of claim 64, wherein the silk fibroin matrix is a hydrogel.

67. The method of claim 63, wherein the surfactant is present in the ink composition in an amount between 0.05 to 10% (w/w).

68. The method of claim 63, wherein the surfactant is cationic.

69. The method of claim 68, wherein the cationic surfactant comprises an alkyl-amino moiety, decyl trimethyl ammonium bromide, dodecyl trimethyl ammonium bromide, cetyl trimethyl ammonium bromide, stearyl trimethyl ammonium bromide, or combinations thereof.

70. The method of claim 62, wherein the ink composition is characterized as having a viscosity that ranges between 1 cP and 10 cP and/or as having silk fibroin present in an amount between 1 to 10% (w/w).

71. The method of claim 62, wherein the ink composition comprises at least one of a pigment, a conductive ink, and an active biomolecule.

72. The method of claim 62, wherein the array of sensing elements is in contact with a first surface of the substrate forming a pattern across the first surface, the sensing elements being transformable from a first chemical-physical state to a second chemical-physical state in response to a change in the environmental parameter.

73. The method of claim 62, wherein the environmental parameter is at least one of pH, temperature, pressure, humidity, a concentration of a contaminant, bacteria, a toxin, or a metabolite in sweat.

74. The method of claim 62, wherein detecting comprises generating a map of the environmental parameter.

75. The method of claim 62, wherein the environmentally-responsive dye is selected from the group consisting of a pH-sensitive dye, a thermal sensitive dye, or a pressure sensitive dye, optionally wherein the pH-sensitive dye is selected from bromocresol green, nitrazine yellow, phenol red, and combinations thereof.

76. The method of claim 62, wherein a pH is extrapolated from a calibration model obtained after processing the image that relates pH and RGB intensities.

77. The method of claim 62, wherein the array of sensing elements indicates a presence or absence of an analyte of interest, and/or includes unique codes composed entirely or partly of sensing elements, the unique codes appearing or disappearing upon detection of the analyte of interest.

78. The method of claim 62, wherein the substrate is at least one of fabrics, woods, plastics, papers, leathers, metals, stones, concretes, rubbers, glasses, paints, semiconductors, plasters, and foams.

79. A method of colorimetric lactate sensing,
contacting an array of sensing elements printed on a substrate with sweat, each of the sensing elements comprising silk fibroin, lactate oxidase, peroxidase, a chromogenic dye system, and optional reference indicia, wherein the array of sensing elements undergoes a colorimetric change in response to the contacting; and
determining a lactate concentration from the colorimetric change of the array.

80. The method of claim 79, wherein the array of sensing elements further comprises a thickener and a plasticizer.
